(19) United States
(12) Patent Application Publication
(10) Pub. No.: US 2016/0132981 A1
(43) Pub. Date: May 12, 2016

(54) EMERGENCY PLANNING SYSTEM AND METHOD

(71) Applicants: Tina M. Cherry, Shelbyville, IN (US); Gregory A. Cherry, Shelbyville, IN (US)

(72) Inventors: Tina M. Cherry, Shelbyville, IN (US); Gregory A. Cherry, Shelbyville, IN (US)

(21) Appl. No.: 14/827,800

(22) Filed: Aug. 17, 2015

Related U.S. Application Data
(60) Provisional application No. 62/038,004, filed on Aug. 15, 2014.

(51) Int. Cl. G06Q 50/26; G06Q 10/00

(52) U.S. Cl. CPC G06Q 50/265; G06Q 10/00

(57) ABSTRACT

Methods, systems, and kits for an emergency planning system. In one aspect, a method includes selecting a geographic location, receiving an aerial representation of the geographic location, overlaying the aerial representation with at least one icon, generating location emergency data for the geographic location based on the aerial representation and the at least one icon overlay, and publishing the location emergency data. Other aspects include receiving an emergency request associated with the geographic location, querying at least one database for the location emergency data associated with the geographic location, receiving the location emergency data for the geographic location on at least one user device, condensed information sheets, materials sheets, preprinted icon sheets for overlaying aerial representation, accessing location emergency data on user device(s) by emergency services, and/or integration of GPS and/or other telemetry measurements.

### CROSS-REFERENCE TO RELATED APPLICATIONS

This application claims the benefit under 35 U.S.C. §119(e) of U.S. Patent Application No. 62/038,004, entitled “EMERGENCY PLANNING SYSTEM AND METHOD,” filed Aug. 15, 2014, which is incorporated herein by reference in its entirety.

### BACKGROUND

This specification relates to the field of emergency planning. Modern farms and agricultural installations may be as large as many industrial facilities both in terms of area used, buildings, and equipment. Like industrial facilities, farms frequently store potentially dangerous materials. Chemicals such as gaseous ammonia, nitrogen-based fertilizers, diesel fuel and other petroleum products, pesticides, herbicides, and the like are commonly stored and used on modern farms, often in very large quantities. Smaller amounts of potentially dangerous compounds such as solvents, paints, cleaners, degreasers, and the like may also be present, particularly in workshop areas. Even mostly benign materials such as grain or hay may be dangerous under certain circumstances. Grain dust can be highly explosive and damp hay has been known to spontaneously combust. In addition to potentially dangerous substances, machinery, equipment, and facilities commonly found on farms are potentially hazardous under certain circumstances.

Both manmade disasters (fires, explosions, and the like) and natural disasters (floods, high winds, earthquakes, and the like) may strike farm facilities. First responders arriving at a large farm need to be provided with as much relevant information about the location and type of hazards to be found on the farm. Unlike at a staffed industrial facility where such information may in certain circumstances be provided by a security guard or other employee, many farms are operated by a small number of workers, frequently as small as one or two people. Additionally, these same workers may be trapped, injured, or otherwise unable to aid the first responders. What is needed is a way for providing critical information to first responders in a quick, reliable, and cost-effective manner.

The present novel technology addresses these needs.

### BRIEF DESCRIPTION OF THE DRAWINGS

FIG. 1 is an emergency plan sheet according to one example of the disclosed invention.

FIG. 2 is an emergency plan schematic sheet according to one example of the disclosed invention.

FIG. 3 is an emergency plan sheet according to another example of the disclosed invention.

FIG. 4 is an emergency plan supplemental sheet according to one example of the disclosed invention.

FIG. 5 is one example of icons for use with an emergency planning sheet according to the disclosed invention.

FIG. 6 is another example of icons for use with an emergency planning sheet according to the disclosed invention.

FIG. 7 is one example of a storage unit for the disclosed emergency planning system.

FIG. 8 is one example of a structure housing the disclosed emergency planning system.

FIG. 9 is a kit containing emergency planning system components.

FIG. 10 is an example environment in which the emergency planning system may exist.

FIG. 11 depicts a process flow chart associated with an implementation for the emergency planning system.

FIG. 12 depicts another process flow chart associated with an implementation for the emergency planning system.

FIG. 13 depicts a screenshot of an example locations view of the emergency planning system.

FIG. 14 depicts a screenshot of an example selected location view of the emergency planning system.

FIG. 15 depicts a screenshot of an example contacts view of the emergency planning system.

FIG. 16 depicts a screenshot of an example aerial view of the emergency planning system.

FIG. 17 depicts a screenshot of an example structures view of the emergency planning system.

FIG. 18 depicts a screenshot of an example hazards view of the emergency planning system.

FIG. 19 depicts a screenshot of an example water sources view of the emergency planning system.

FIG. 20 depicts a screenshot of an example notes view of the emergency planning system.

FIG. 21 is a system diagram of an example computer system that may be used to create the emergency planning system.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that the emergency planning system 300, client, end user (user, system user), and/or module may produce some event or cause some event element to be produced. For example, a webpage may receive data to display in whole or in part to display a valuation estimate to an end user device, the webpage may pull such data from a source other than the emergency planning system 300 (e.g., other servers, intermediaries, etc.), or the emergency planning system 300 may entirely provide the valuation estimate to be produced on the webpage.

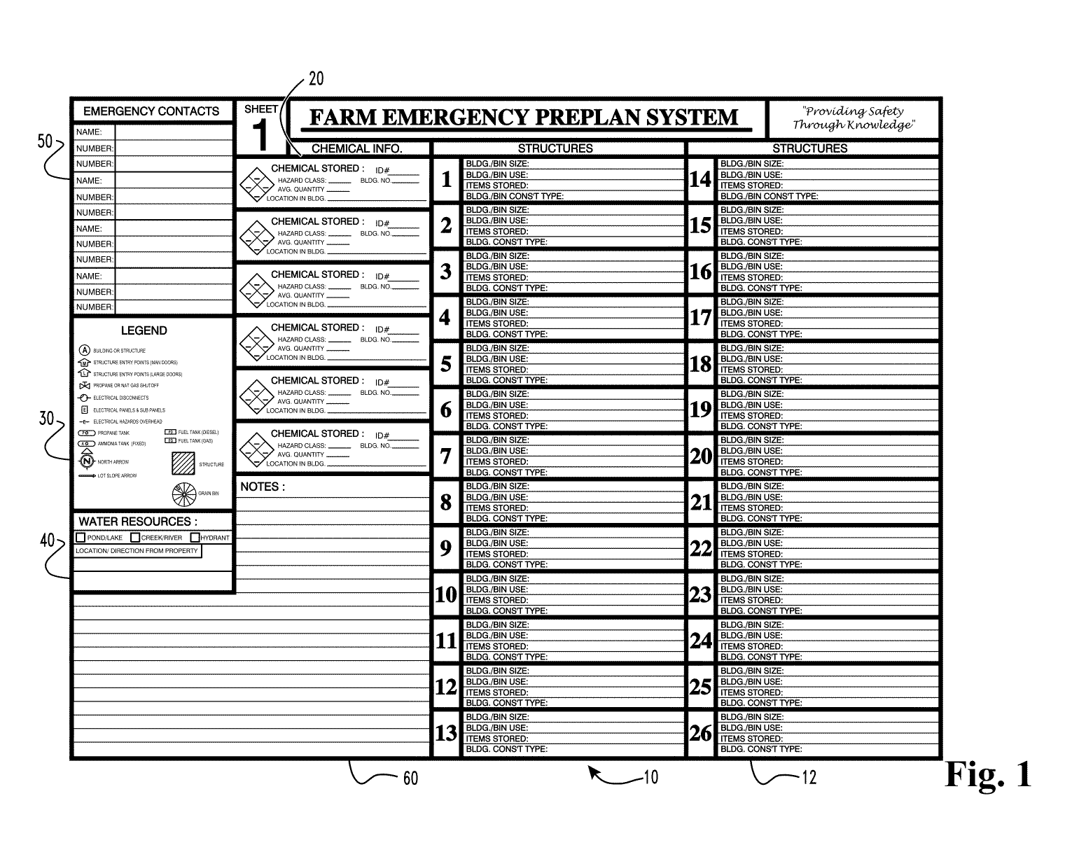

FIG. 1 depicts one example of the disclosed system that features laminated information sheets having emergency contact information, one or more drawing areas using stickers representing buildings and structures, grain bin locations, fire hazards that are in those buildings, shut off valves, electrical panel locations, reflective numbers for buildings, water sources, chemicals stored, additional notes, and/or the like. Additional notes, comments, or instructions may be written on the sheets. Optionally, the system further includes a Chemical Involved area on the sheet, which lists the hazard classes, building number(s), average quantity, and chemical number in the form of the NFPA® 704 diamond (NFPA is a registered trademark of National Fire Protection Association, Inc., a Massachusetts corporation, located at One Batterymarch Park, Quincy, Mass. 02169) (or other suitable hazard identification system) of chemicals stored on site.

The information once filled out may then be placed in a protective container that has a reflective sticker or other means for making it highly visible which is attached to a post or pole near the front of the farm. Optionally, copies of the plan are placed in similar protective containers at other entrances to the farm and/or at a central or obvious staging area such as a house or parking lot. In this particular embodiment, a copy of the plan and a letter explain where the plan may be located on the farm may be sent to the local first responders such as the sheriff's office and fire department. As many farms are located in areas served by volunteer fire departments, additional copies may be provided if desired.

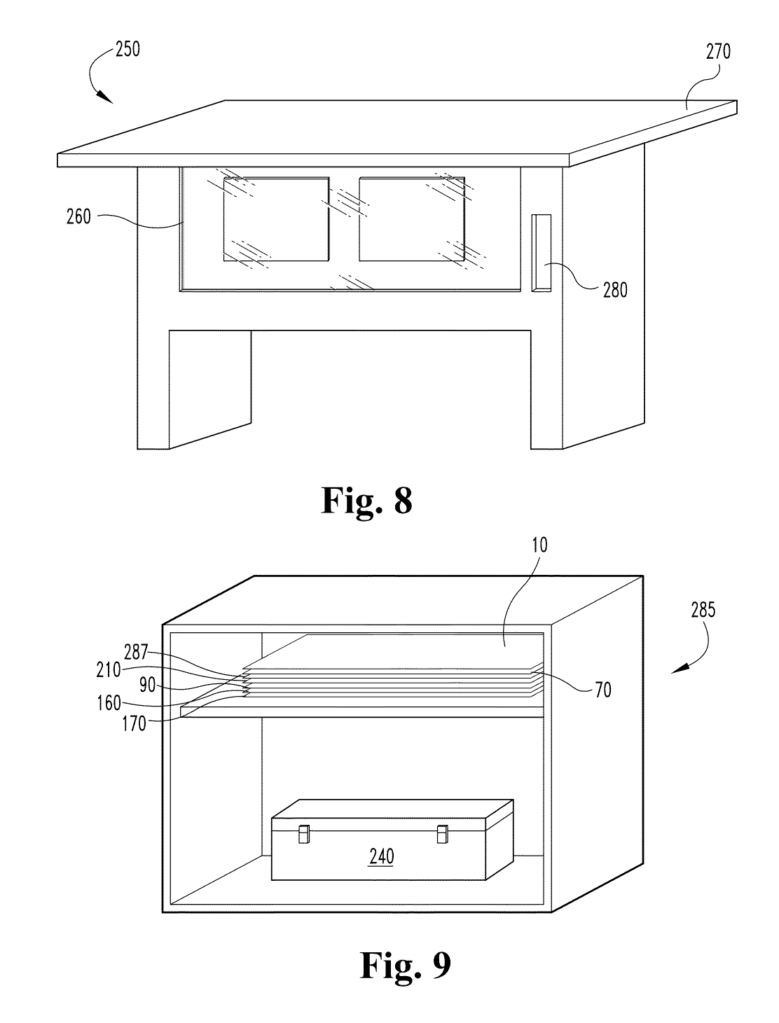

In another embodiment, in addition to smaller, more portable versions of the information sheets a larger version of the sheet 260 is posted at a site both visible by and accessible to first responders. Such a site may be a purpose-built shelter 250 such as is shown in FIG. 8 or on the side of an existing structure. The shelter 250 may include an overhang 270 to shelter the to protect the sheet 260 and first responders from the elements as well as a storage box 280 which may include smaller versions of the information sheet as well as writing instruments suitable for erasably writing on the larger version of the information sheet 260 so that users may write on the sheet during an emergency.

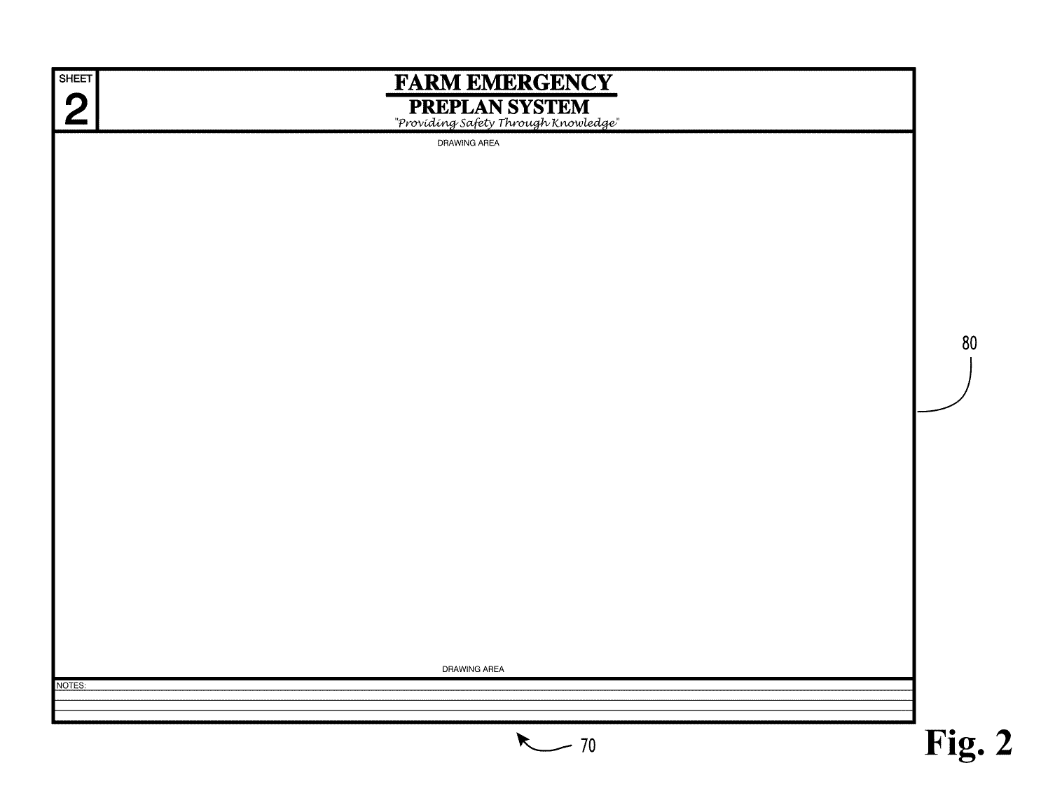

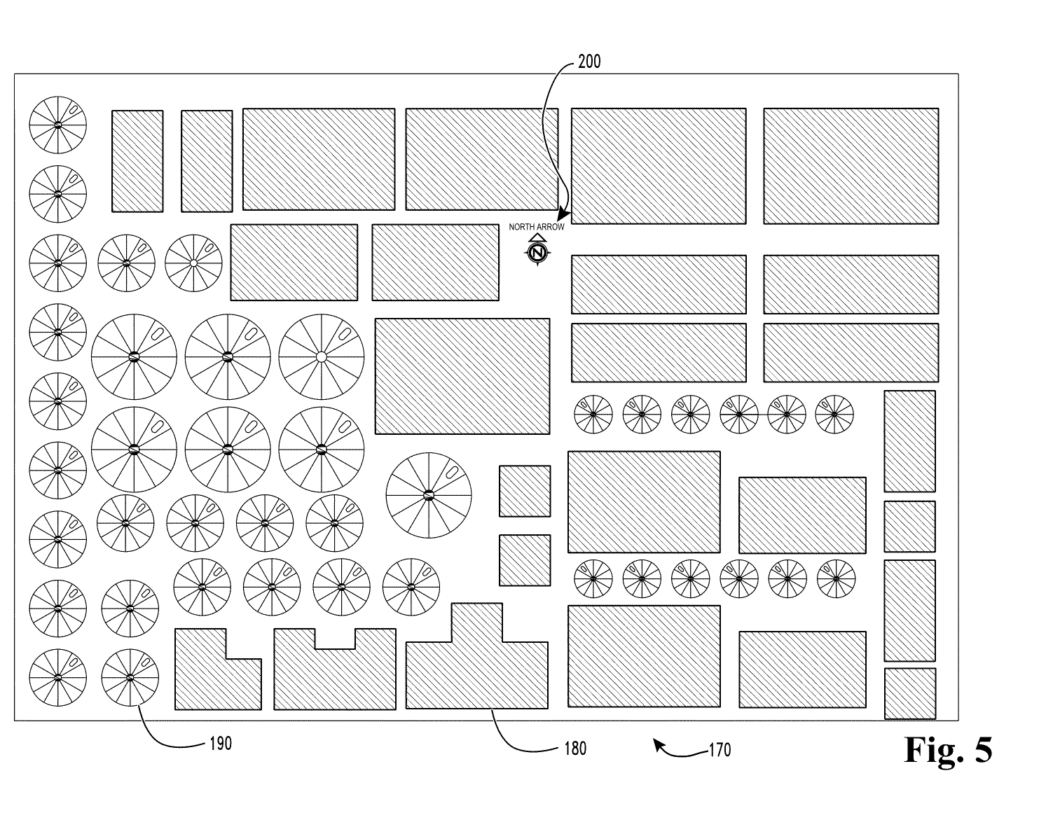

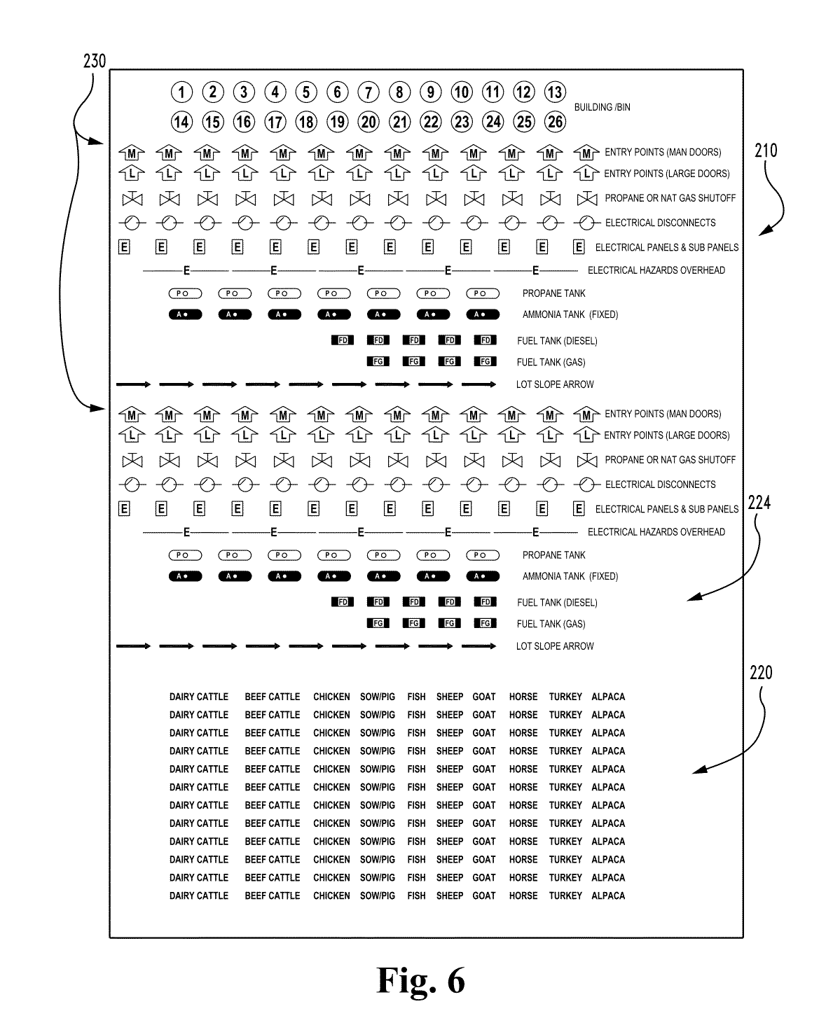

In another example of the disclosed invention as shown in FIGS. 1-2, an information sheet 10 includes areas for information including building descriptions 12, chemicals stored on site 20, emergency contact numbers 50, and a legend describing any symbols used 30. As farms are typically not located near municipal water systems, and therefore not near fire hydrants, a section describing the nature and location of available water sources 30 may also be included. The chemicals stored section may use an identification system such as the NFPA® 704 color-coded system or some other suitable system for identifying hazardous substances. A second information sheet 70 may also be included. This sheet 70 includes a space 80 for drawing a schematic of the farm area and may indicate building locations, chemical storage sites, power sources, water sources, and other relevant information for first responders. Optionally, it may also indicate the name(s) and likely location(s) of workers typically found on the site and the time(s) they may be found there. For example, if a worker is always milking cows in a milking parlor at the hours of 6 am, 2 pm, and 10 pm that information may be displayed in the space 80 for the farm schematic near the symbol indicating the milking parlor. Optionally, sheets of preprinted icons 170, 210 for buildings, equipment, and other information such as shown in FIGS. 5-6 may also be used. These icons may be printed as stickers, cardboard cutouts, magnets, and the like. Examples of icons indicating particular structures include those for buildings 180, silos or grain bins 190, or other facilities. Icons indicating information include directions 200, building numbers, entry points, pumps, circuit breakers 230, materials storage such as propane tanks, diesel and gasoline tanks 224, and/or the like. The contents of buildings may also be indicated using different labels such as to indicate where animals are housed as well as the type of animal(s) 220.

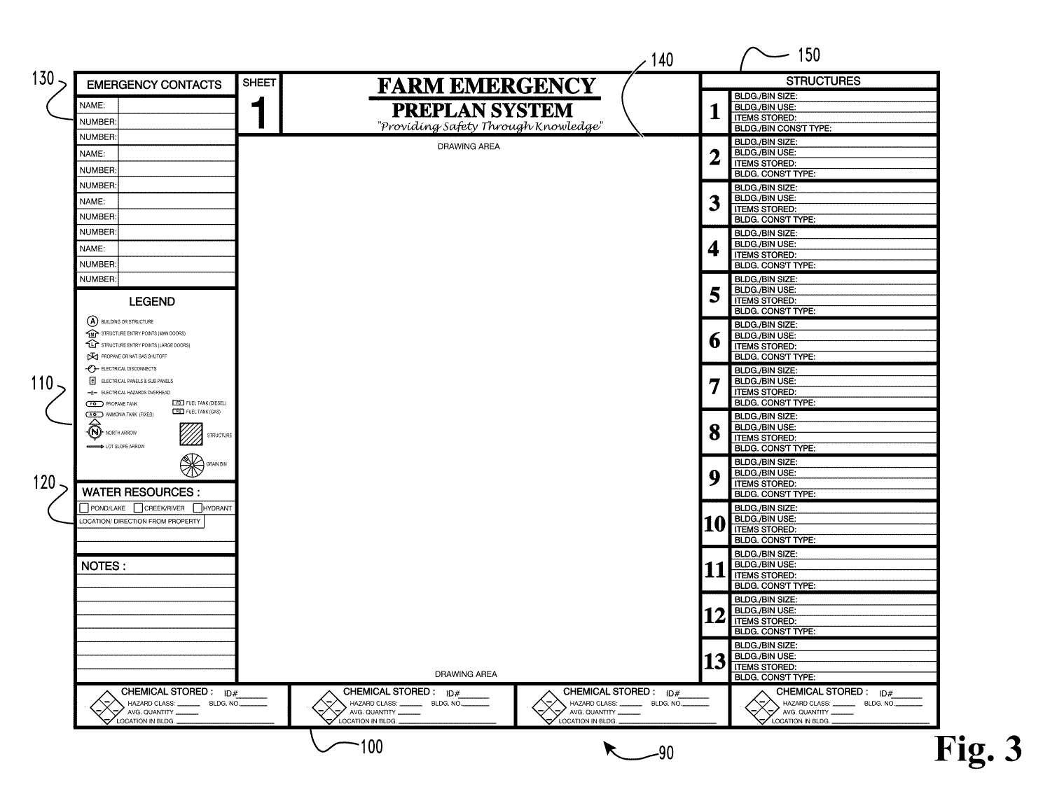

In another example shown in FIG. 3, the information sheets shown in FIGS. 1-2 may be condensed into a single sheet 90. Such a condensed sheet may be suitable for smaller facilities or as a single-sheet reference which may be handed out to individual first responders during an emergency. The same type of information contained in the sheets shown in FIGS. 1-2 may also be included in the single sheet such as chemical hazards 100 stored on site, a listing of structures 150, a schematic of the area 140, contact info 130, water resources 120, and a legend 110 explaining symbols used in the schematic.

In another example, additional information on hazardous materials stored on site may be complied in an additional sheet 160. This sheet can include additional relevant information about materials stored on site and may be included as an additional sheet with other information sheets shown in FIGS. 1-3, or may be stored on site in a visible and accessible location. Such additional sheets may be used where certain materials are only used during a portion of the year (for example, anhydrous ammonia) or for materials which have only recently been brought on site after the initial information sheet(s) was produced.

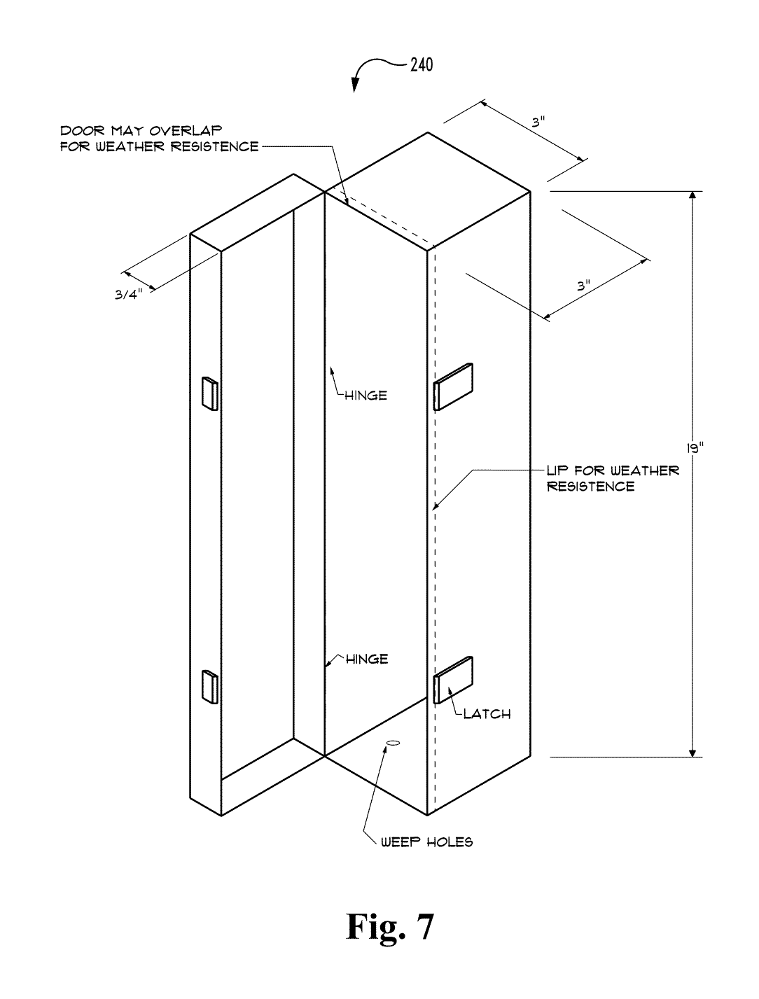

The information sheets shown in FIGS. 1-6 may be stored on site at one or more locations where they will be easily spotted and accessed by first responders. One example of such a storage mechanism is a weather-resistant box 240 such as shown in FIG. 7. Such a box could be placed on a post near each access road to a facility, optionally with a highly visible flag or sign indicating that an emergency plan may be found within. In other examples, a flashing indicator light (such as a strobe) may be located on or near the box. The light may be activated, for example, whenever a fire or other alarm is activated on the facility. In other examples, the light may be activated by calling or texting a particular phone number.

In another embodiment, large and/or highly visible/reflective indicia may be added to buildings and other structures. These indicia would correspond with the number(s) and/or symbols used on the information sheet(s) and/or the schematic of the farm. The indicia could be placed at multiple points on larger structures so that emergency responders could quickly identify buildings from more than one direction of approach. The indicia could be made of metal, plastic, or other suitable material and optionally could be made of a highly-reflective material so as to be visible in low light or other conditions of poor visibility (e.g., smoke, rain, fog, and the like.). In another embodiment, the indicia may be illuminated either constantly or temporarily during emergency situations.

In some implementations, site information sheet 260 may be presented on or as a digital display device (e.g., as one or more end-use devices 330, described below). For example, a touchscreen display and/or display with input/output devices (e.g., devices 830, described below) may be connected to system 300 (described below) to display selected location view 550 (described below) of the geolocation at which site information sheet 260 is located. Thus, site information sheet 260 may be more frequently and conveniently updated (instead of reprinting and laminating sheet 260 for each change at geolocation).

While the present emergency planning system may be used on a farm as described above and/or other agricultural location, the system may also be used for any other geolocation (e.g., industrial sites, commercial complexes, residential areas, and/or the like). For example, when emergency services respond to an emergency request from a shopping mall, factory, and/or apartment complex, the present emergency planning system may allow the emergency responders to more easily, efficiently, and safely reduce and/or eliminate the emergency condition, potentially saving human lives and/or property in the process.

In some implementations, as depicted in FIG. 9, planning system components may be provided as a kit. For example, emergency planning system kit 285 may typically include information sheet 10 (and/or condensed sheet 90), first sheet of preprinted icons 170, second sheet of preprinted icons 210, and/or weather-resistant box 240.

In some other implementations, kit 285 may include the information sheet 10 with the completed aerial representation of the geolocation, whereas in other implementations, the aerial representation of the geolocation may be provided by the kit 285 manufacturer, a third-party, and/or the kit recipient. In some additional implementations, the aerial representation may be a separate component in kit 285. For example, the aerial representation may be, but is not limited to, an adhesive-coated sheet having an image printed thereon that may be placed and adhered to information sheet 10, condensed sheet, 90, and/or the like.

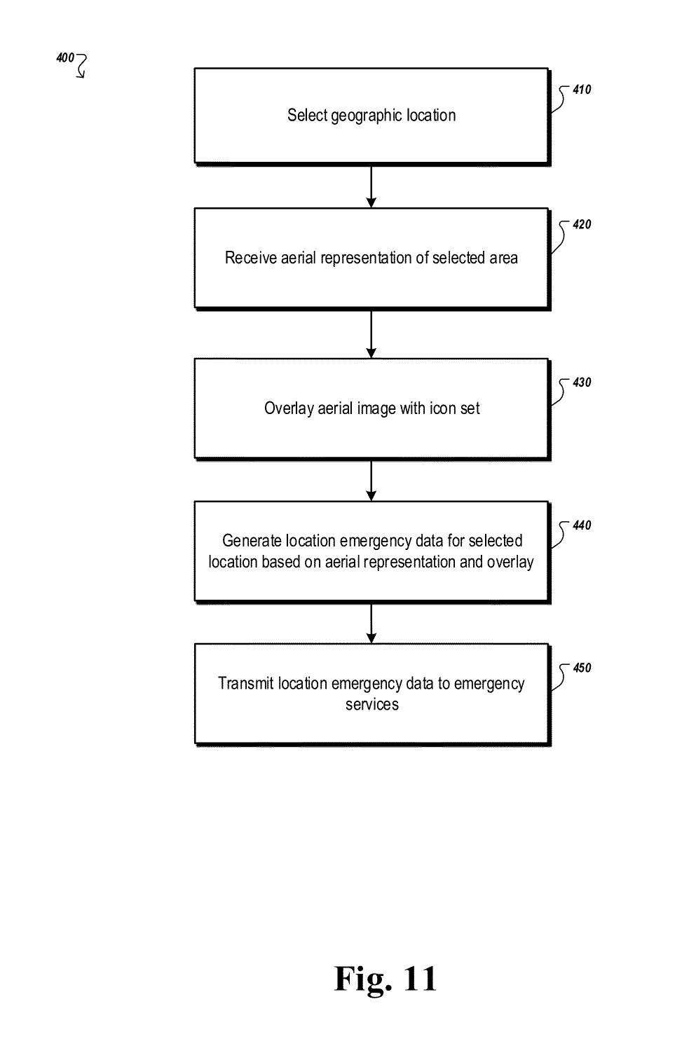

In some further implementations, kit 285 may also and/or instead include a subscription 287 to system 300 software for creation of information sheet 10 (and/or condensed sheet 90) using the location emergency data creation method described below in this application with reference to FIG. 11.

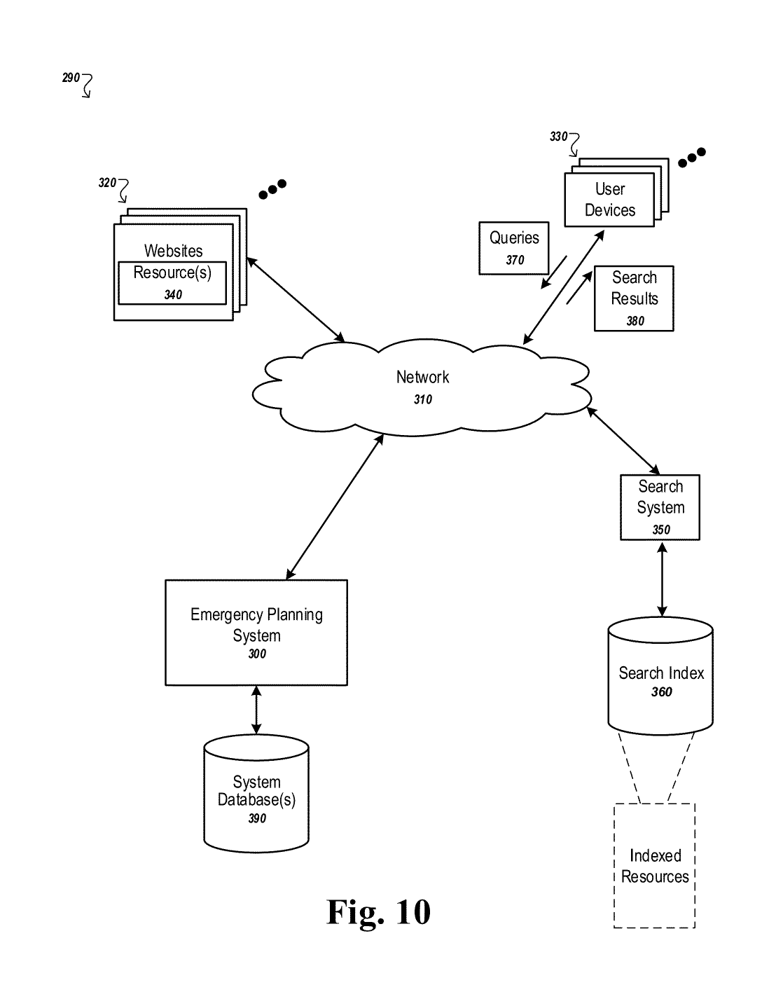

FIG. 10 is a block diagram of an example environment 290 in which emergency planning system 300 may exist. Environment 290 may typically include emergency planning system 300; network 310; website(s) 320; end user device(s) 330; resource(s) 340; search system 350; search index 360; queries 370; search result(s) 380; and system database(s) 390. Emergency planning system 300 may facilitate creation and dissemination of geolocation emergency data. Example environment 290 also includes network 310, such as a local area network (LAN), a wide area network (WAN), the Internet, or a combination thereof. Network 310 may connect websites 320, end user device(s) 330, and/or emergency planning system 300. Example environment 290 may potentially include many thousands of website(s) 320 and/or end user device(s) 330.

Website(s) 320 may be one or more resources 340 associated with a domain name and hosted by one or more servers. An example website(s) 320 may be a collection of webpages formatted in hypertext markup language (HTML) that may contain text, images, multimedia content, and programming elements, such as scripts. Each website(s) 320 may be maintained by a publisher, which may be an entity that controls, manages, and/or owns each website(s) 320.

Resource(s) 340 may be any data that may be provided over the network 310. A resource(s) 340 may be identified by a resource address (e.g., a URL) that may be associated with the resource(s) 340. Resources 340 include HTML webpages, word processing documents, and portable document format (PDF) documents, images, video, and feed sources, to name only a few. Resources 340 may include content, such as words, phrases, images and sounds, that may include embedded information—such as meta-information in hyperlinks—and/or embedded instructions, such as JAVASCRIPT scripts (JAVASCRIPT is a registered trademark of Sun Microsystems, Inc., a Delaware corporation, located at 4150 Network Circle Santa Clara, Calif. 95054). Units of content—for example, data files, scripts, content files, or other digital data—that may be presented in (or with) resources may be referred to as content items.

End user devices 330 may be electronic devices that may be under the control of an end user and may be capable of requesting and receiving resources 340 over network 310. Example end user devices 330 include personal computers, mobile communication devices, and other devices that may send and receive data over the network 310. End user devices 330 typically include a user application, such as a web browser, to facilitate the sending and receiving of data over the network 310.

In some implementations, websites 320 (apps, client services; hereinafter simply “websites” for ease of use), end user devices 330, and system 300 may directly intercommunicate, excluding the need for the Internet from the scope of a network 310. For example, the websites 320, end user devices 330, and the emergency planning system 300 may directly communicate over device-to-device (D2D) communication protocols (e.g., WI-FI DIRECT (WI-FI DIRECT is a registered trademark of Wi-Fi Alliance, a California corporation, located at 10900-B Stonelake Boulevard, Suite 126, Austin, Tex. 78759); Long Term Evolution (LTE) D2D (LTE is a registered trademark of Institut Europeen des Normes; a French nonprofit telecommunication association, located at 650 route des Lucioles, F-06921, Sophia Antipolis, France), LTE Advanced (LTE-A) D2D, etc.), wireless wide area networks, and/or satellite links thus eliminate the need for the network 310 entirely. In other implementations, the websites 320, end user devices 330, and system 300 may communicate indirectly to the exclusion of the Internet from the scope of the network 310 by communicating over wireless wide area networks and/or satellite links. Further, end user devices 330 may similarly send and receive search queries 370 and search results 380 indirectly or directly.

In wireless wide area networks, communication primarily occurs through the transmission of radio signals over analog, digital cellular, or personal communications service (PCS) networks. Signals may also be transmitted through microwaves and other electromagnetic waves. At the present time, most wireless data communication takes place across cellular systems using second generation technology such as code-division multiple access (CDMA), time division multiple access (TDMA), the Global System for Mobile Communications (GSM) (GSM is a registered trademark of GSM MoU Association, a Swiss association, located at Third Floor Block 2, Deansgrande Business Park, Deansgrande, Co Dublin, Ireland), Third Generation (wideband or 3G), Fourth Generation (broadband or 4G), personal digital cellular (PDC), or through packet-data technology over analog systems such as cellular digital packet data (CDPD) used on the Advance Mobile Phone System (AMPS).

The terms “wireless application protocol” and/or “WAP” mean a universal specification to facilitate the delivery and presentation of web-based data on handheld and mobile devices with small user interfaces. “Mobile Software” refers to the software operating system that allows for application programs to be implemented on a mobile device such as a mobile telephone or PDA. Examples of Mobile Software are JAVA and JAVA ME (JAVA and JAVA ME are trademarks of Sun Microsystems, Inc. of Santa Clara, Calif.), BREW (BREW is a registered trademark of Qualcomm Incorporated of San Diego, Calif.), WINDOWS Mobile (WINDOWS is a registered trademark of Microsoft Corporation of Redmond, Wash.), PALM OS (PALM is a registered trademark of Palm, Inc. of Sunnyvale, Calif.), SYMBIAN OS (SYMBIAN is a registered trademark of Symbian Software Limited Corporation of London, United Kingdom), ANDROID OS (ANDROID is a registered trademark of Google, Inc. of Mountain View, Calif.), and IPHONE OS (IPHONE is a registered trademark of Apple, Inc. of Cupertino, Calif.), and WINDOWS PHONE 7 (WINDOWS PHONE is a registered trademark the Microsoft Corporation of Redmond, Wash.). “Mobile Apps” refers to software programs written for execution with Mobile Software.

The emergency planning system 300 may use one or more modules to perform various functions including, but not limited to, searching, analyzing, querying, interfacing, etc. A “module” refers to a portion of a computer system and/or software program that carries out one or more specific functions and may be used alone or combined with other modules of the same system or program. For example, a module may be located on the emergency planning system 300 (e.g., on the servers of system 300, i.e., server-side module), on end user devices 330, or on an intermediary device (e.g., the client server, i.e., a client-side module; another end user device(s) 330; a different server on the network 310; or any other machine capable of direct or indirect communication with system 300, websites 320, the search system 350, and/or the end user devices 330.)

In some implementations, the system 300 may be performed through a system 300 module. For example, a user may install a program to interface with a system 300 server to communicate data, interactions, and resources 340 to the user's end user device(s) 330. In some other implementations, the system 300 may be installed on a user's machine and operate—in whole or in part—independently of system 300 WAN and/or LAN components. For example, the system 300 software may be deployed to a user's computer as a standalone program that interfaces with the user's computer, stores location emergency data, retrieves queried location emergency data, and displays retrieved location emergency data. In another example, the system 300 may interact with and/or be installed as an Internet browser extension. For example, the system 300 may be a program installed as an extension, add-on, and/or plugin of GOOGLE CHROME (GOOGLE CHROME is a registered trademark of Google, Inc., a Delaware corporation, located at 1600 Amphitheatre Parkway, Mountain View, Calif. 94043); MOZILLA FIREFOX (MOZILLA and FIREFOX are registered trademarks of the Mozilla Foundation, a California non-profit corporation, located at 313 East Evelyn Avenue, Mountain View, Calif. 94041); APPLE SAFARI (APPLE and SAFARI are registered trademarks of Apple, Inc., a California corporation, located at 1 Infinite Loop, Cupertino, Calif. 95014), etc. The browser extension may receive a location from a user, a digital notification (e.g., emergency notification system and/or any other mechanism for inputting a location), query system database 390 for that location, retrieve location emergency data (e.g., a digital version of completed information sheets 10, condensed sheet 90, and/or the like), and then display that retrieved data in the browser to a viewer.

In some implementations, retrieval of stored emergency data may be accomplished through a user's input of commands. For example, a user may vocally command the system 300 to search for a location while en route to a location by saying, “Retrieve data for [address” (where address is the location), or issue specific commands (e.g., saying “Show me gas shutoff valve” while browsing location data, and the location's gas shutoff valve may be highlighted and/or otherwise indicated to the user on the display). In another example, a user may input commands on an input device (e.g., a keyboard, touchpad, etc.) to command the system 300.

Typically, modules may be coded in JAVASCRIPT, PHP, or HTML, but may be created using any known programming language (e.g., BASIC, FORTRAN, C, C++, C#, PERL (PERL is a registered trademark of Yet Another Society DBA The Perl Foundation, a Michigan nonprofit corporation, located at 340 S. Lemon Ave. #6055, Walnut, Calif. 91789)) and/or package (e.g., compressed file (e.g., zip, gzip, 7zip, RAR (RAR is a registered trademark of Alexander Roshal, an individual, located in the Russian Federation AlgoComp Ltd., Kosareva 52b-83, Chelyabinsk, Russian Federation 454106), etc.), executable, etc.).

In some implementations, the emergency planning system 300 may be packaged, distributed, scripted, installed by a technician of system 300, and/or otherwise deployed to a client server location such that system 300 exists within the client server and/or client server network, either in whole or in part. For example, the emergency planning system 300 may be scripted and/or packaged into an executable package and downloaded by a client administrator; the client administrator then installing system 300 software package(s) onto the client server(s). Such setups may allow the emergency planning system 300 to operate all system 300 operations entirely within the client server(s) and/or client network, excluding the need to interface with system 300 provider's servers for some or all system 300 functions. Such an implementation may, for example, be used to reduce bandwidth, latency, complexity of network management, etc. In some other implementations, the client servers may facilitate only some of system 300 functions and interface with system 300 servers (over a network or directly) to enable those remaining functions. Still other implementations may link to system 300 servers to obtain updates, patches, and/or other modifications to system 300 distributions.

Emergency planning system 300 software distributions may, in some implementations, be installed in a virtual environment (e.g., HYPER-V (HYPER-V is a registered trademark of Microsoft, a Washington Corporation, located at One Microsoft Way, Redmond, Wash. 98052); VIRTUALBOX (VIRTUALBOX is a registered trademark of Oracle America, Inc., a Delaware corporation, located at 500 Oracle Parkway, Redwood Shores, Calif. 94065); VMWARE (VMWARE is a registered trademark of VMWare, Inc., a Delaware corporation, located at 3401 Hillview Ave., Palo Alto, Calif. 94304), etc.).

In other implementations, emergency planning system 300 software may be installed in whole or in part on an intermediary system that may be separate from the client and system 300 servers. For example, emergency planning system 300 software may be installed by an intermediary worker, a client worker, and/or a system 300 worker onto a hosting service (e.g., AMAZON WEB SERVICES (AWS) (AWS is a registered trademark of Amazon Technologies, Inc., a Nevada corporation, located at PO Box 8102, Reno, Nev. 89507), RACKSPACE (RACKSPACE is a registered trademark of Rackspace US, Inc., a Delaware corporation, located at 1 Fanatical Place, City of Windcrest, San Antonio, Tex. 78218), etc. The client may then connect to the intermediary and/or system 300 servers to access system 300 functions. Such implementations may, for example, allow distributed access, redundancy, decreased latency, etc.

End user device(s) 330 may request resources 340 from website(s) 320. In turn, data representing resource(s) 340 may be provided to end user device(s) 330 for presentation by end user device(s) 330. Data representing resource(s) 340 may also include data specifying a portion of the resource(s) 340 or a portion of a user display—for example, a small search text box or a presentation location of a pop-up window—in which advertisements or third-party search tools may be presented.

To facilitate searching of resource(s) 340, environment 290 may include a search system 350 that identifies resource(s) 340 by crawling and indexing resource(s) 340 provided by publishers on website(s) 320. Data about resource(s) 340 may be indexed based on resource(s) 340 to which the data corresponds. The indexed and, optionally, cached copies of resource(s) 340 may be stored in, for example, search index 360.

End user device(s) 330 may submit search queries 370 to search system 350 over network 310. In response, search system 350 accesses search index 360 to identify resource(s) 340 that may be relevant to search query 370. Search system 350 identifies the resources 340 in the form of search result(s) 380 and returns the search result(s) 380 to end user devices 330 in search results webpages. A search result(s) 380 may be data generated by the search system 350 that identifies a resource(s) 340 that may be responsive to a particular search query, and includes a link to the resource(s) 340. An example search result(s) 380 may include, but is not limited to, a webpage title, a snippet of text or a portion of an image extracted from the webpage, a geolocation, a map, and/or the URL of the webpage.

Users that may be interested in a particular subject may perform a search by submitting one or more queries 370 to search system 350 in an effort to identify related information. For example, a user that may be interested sports may submit queries 370 such as “Johnson County,” “Main Street,” or “Jones Farm.” In response to each of these queries 370, the user may be provided search result(s) 380 that have been identified as responsive to the search query—that is, have at least a minimum threshold relevance to the search query, for example, based on cosine similarity measures and/or clustering techniques. The user may then select one or more of the search result(s) 380 to request presentation of a webpage or other resource(s) 340 that may be referenced by a URL associated with the search result(s) 380.

When search result(s) 380 are requested by an end user device(s) 330, the emergency planning system 300 may receive a request for data to be provided with the resource(s) 340 or search results 380. In response to the request, the emergency planning system 300 selects data that are determined to be relevant to the search query. In turn, the selected data are provided to the end user device(s) 330 for presentation with the search results 380.

For example, in response to the search query “Jones Farm Johnson County,” system 300 may present the user with relevant farm and/or geolocation-related results. If the user selects—for example, by clicking or touching—search result(s) 380, the end user device(s) 330 may be redirected, for example, to a webpage containing emergency information of one or more Jones Farms, some of which preferably are located in a Johnson County. This webpage may include, for example, contact information for each result, the state of each result, the distance to each result from the end user device 330, etc.

The environment 290 may also include a system database(s) 390 to receive and record information regarding the emergency planning system 300, website(s) 320, end user devices 330, and/or any other data useful to environment 290. For example, information regarding end user devices 330 and end user identifiers may be stored and analyzed to determine user activity on website(s) 320 and/or system 300.

FIG. 11 depicts a process flow chart associated with an implementation for the emergency planning system, typically during location emergency data creation 400. Location emergency data creation 400 typically may include the steps of “select geographic location” 410, “receive aerial representation of selected area” 420, “overlay aerial image with icon set” 430, “generate location emergency data from selected location based on aerial representation and overlay” 440, and/or “transmit location emergency data to emergency services” 450.

Typically, during the “select geographic location” 410 step, a geographic location may be selected for use in system 300. For example, the geographic location may be, but is not limited to, a global positioning system (GPS) coordinate (e.g., 39.7713425 decimal degrees latitude by −86.157379 decimal degrees longitude; 39 degrees, 46 minutes, 16.833 seconds north by 86 degrees, 9 minutes, 26.535 seconds west; and/or the like), a relative political description (e.g., 100 West State Street, Indianapolis, Ind., United States), a recorded description (e.g., plat 55, North Road Subdivision, Nashville, Tenn., United States), a descriptive region (e.g., French Quarter, New Orleans, La.), and/or any other geographic descriptor.

In some implementations, system 300 and/or a system 300 user may select a geographic location automatically (e.g., populating based on current location; a list of potential locations, such as those registered to the user on a public database; radio triangulation; wireless access databases; and/or any other mechanism of geographic notification), while in other implementations, the geographic location may be input manually and/or semi-automatically.

Additionally, during the “receive aerial representation of selected area” 420 step. Typically, once a geographic location has been selected, system 300 may receive an aerial representation of the selected geographic area. For example, if the selected geolocation is Washington, D.C., the aerial representation typically may be associated with the physical and/or political boundaries of the Washington, D.C. area.

In some other implementations, the aerial representation may be associated with an area having greater or lesser relevance to the selected geographic area. For example, system 300 may receive an aerial representation of the political boundaries of Washington, D.C., buffered by a radius of two miles surrounding the political boundaries of Washington, D.C.

In some further implementations, for example where the selected geographic area may be irregularly shaped (e.g., a long, thin area of land, a small area adjacent to a larger area, and/or the like), system 300 may receive a geographic area buffered at the exterior to at a preferred ratio. For example, a geographic area that is originally a 1:4 ratio of dimensions may be buffered to also depict the surrounding area and bring the ratio to 4:3, 16:9, and/or any other preferred ratio.

In still further implementations, system 300 may highlight, add borders to, and/or otherwise emphasize the selected geographic area within the aerial representation. For example, system 300 may fade the surrounding area outside the selected geographic area, topographically differentiate (e.g., pulling the selected area away (i.e., subjectively toward the viewer's vantage point) from the surrounding nonselected area), and/or indicate/generate a distinguishable border around the selected geographic area. This process may similarly be done in any other steps prior to, or contemporaneous with, display of the ultimate overlaid aerial view to a user. By making such graphical distinction, system 300 typically may differentiate and/or better depict the selected geographic area for viewing.

In some implementations, the received aerial representation may be a realistic representation of the selected geographic area, while in other implementations, the aerial representation may be a non-real world depiction of the geographic area. For example, system 300 may receive aerial imagery from an aerial photography source, while in other implementations, the received aerial view may be a purely political style of depiction. Typically, purely political depiction aerial views may also have structures (e.g., barns, houses, pumps, electrical lines, and/or the like) added. In some other implementations, structural features for political depictions may be derived from aerial photography. For example, the structures may be automatically, semi-automatically, and/or manually mapped on a political depiction by way of edge, contour, and/or differential image mapping.

Further, during the “overlay aerial image with icon set” 430 step, the received aerial representation may be layered with one or more sets of icons available through system 300. These icon sets may be, but are not limited to, those depicted and described with relation to FIGS. 5, 6, 16, and/or 17. A user typically may interact with system 300′s user interface to map the location of the structures associated with the icon sets onto the aerial representation of the selected geographic area. For example, system 300 may generate and display the retrieved aerial representation to the user via end user device 330, the user may select one or more icons to overlay onto the displayed aerial representation (e.g., by tapping, dragging, and/or otherwise interacting with interface), and system 300 may record these relative icon locations (for example, but not limited to, in system databases 390).

In other implementations, overlayment of the icon set on the aerial image may be accomplishing using a listing and relative association (e.g., GPS coordinates) of features to be tagged with icons. For example, system 300 may retrieve an aerial representation of a geographic location, the representation having a guide point/fiducial within the representation (e.g., a centroid, a GPS coordinate, and/or the like). From this point, the system 300 may then populate the overlay using relative and/or absolute locations for the structures. For example, system 300 may receive a list of GPS coordinates associated with a barn, a house, and a silo to associate with structure icons, a water shutoff valve to associate with water source icons, an electrical service breaker panel to associate with electrical service icons, and/or the like. Further, depending on use of absolute location data (e.g., GPS coordinates), relative guide points may be unnecessary.

In another example, system 300 may receive a list of relative points by which to place icons. For example, system 300 may receive an aerial representation of a geographic location centered on a specific GPS location and having a radius of five miles. From this, system 300 may then assign and overlay icons at relative points such as a barn at one-half mile north of the center (i.e., one-tenth of the radius above the center point), a water shutoff valve one mile south of the center (i.e., one-fifth of the radius below the center point), a pond located five hundred and twenty-eight feet west of the water shutoff valve (i.e., one-fifth of the radius below the center and one-fiftieth of a radius to the west of the water shutoff valve (or, after simplification, approximately 5.711 degrees south-southwest of the central point for 5306 feet)), and/or the like.

Additionally, in some implementations, further information may be associated with and/or stored regarding the overlaid icons and geographic area. For example, a first structure indicator may be associated with an animal barn, a second structure indicator may indicate an occupied living quarters, and other icons may indicate gas valves, water sources, and/or the like. Additionally, the stored information regarding the first structure may denote entrances, exits, electrical service, the type and quantity of animals, and/or the like. The second structure indicator may have associated information denoting that four individuals live in the structure, bedrooms are on the first and second floors, smoke detectors are installed, and where the closet water source is located. The same may be indicated by the other icons, such as the type of valves, the size and shape of entrances, the combinations for locks and/or doors, and/or the like. Typically, this information may be accessible through system 300's user interface (e.g., by browsing aerial view 650, structures view 690, hazards view 710, water sources view 730, notes view 750, and/or the like). In some implementations, tapping and/or otherwise selecting an icon through a user device 330 may popup and/or otherwise generate such associated data on the system 300 user interface.

Typically, during the “generate location emergency data from selected location based on aerial representation and overlay” 440 step, a final representation of the selected location typically may be generated including information such as, but not limited to, the aerial representation, icons, location data relative to the aerial representation for the icons, notations regarding the features associated with the icons, and/or the like. System 300 may generate the collective location emergency data as one or more interconnected files (e.g., hypertext, images, and/or the like), which may then be made available as one or more files via the system 300's user interface and/or any other platform for distribution (e.g., a separate website, a browseable data file container, and/or the like).

Additionally, during the “transmit location emergency data to emergency services” 450 step, the generated location emergency data may be transmitted to a location accessible by emergency services personnel. The emergency services personnel typically may then access the location emergency data when responding to an emergency services request, inspection, and/or any other situation where such information may be useful. Location emergency data may, in some implementations, be stored on system 300 (e.g., in system databases 390), while in other implementations, location emergency data may be distributed and/or stored on systems belonging to the emergency services, third-parties, and/or any other accessible system.

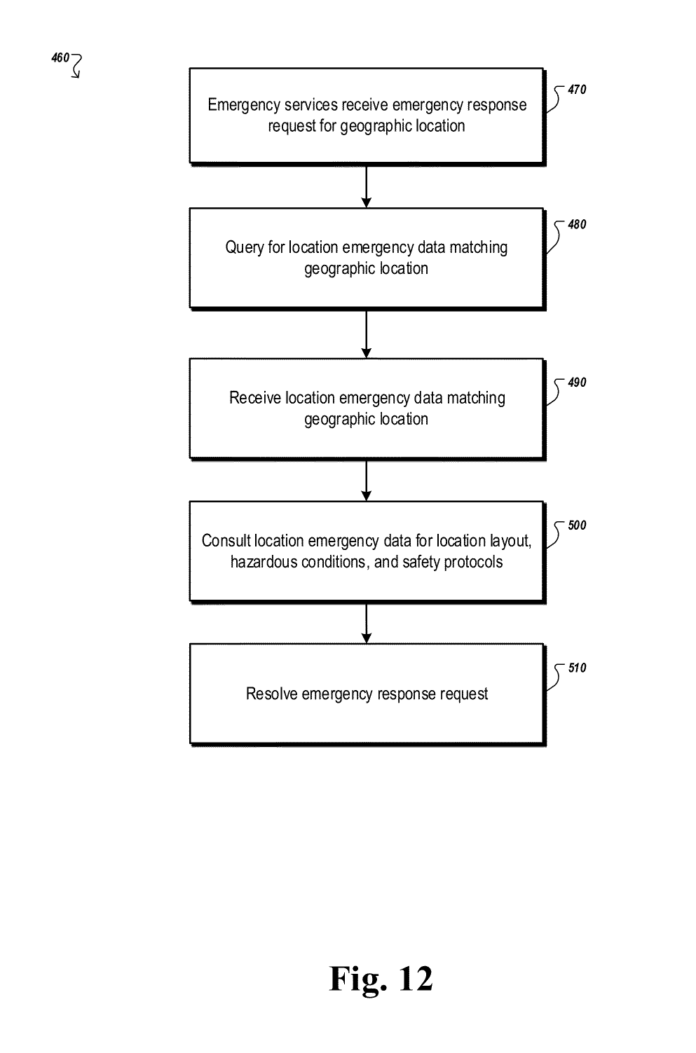

FIG. 12 depicts another process flow chart associated with an implementation for the emergency planning system, typically during emergency response process 460. Emergency response process 460 typically may include the steps “emergency services receive emergency response request for geographic location” 470, “query for location emergency data matching geographic location” 480, “receive location emergency data matching geographic location” 490, “consult location emergency data for location layout, hazardous conditions, and safety protocols” 500, and/or “resolve emergency response request” 510.

Typically, during the “emergency services receive emergency response request for geographic location” 470 step, one or more emergency services contacts receive emergency response requests for a geographic location. For example, a farmer may call 911 on a phone, send a text, trigger an emergency beacon, an alarm may be set off, and/or otherwise contact the one or more emergency services operators. The one or more emergency services contacts may then dispatch emergency service operators (e.g., a firetruck, a law enforcement patrol, and/or the like) to respond to the response request.

During the “query for location emergency data matching geographic location” 480 step, the responding emergency service operator(s), may access the location emergency data on system 300 from a user device 330 via an application, web portal, and/or link. In some implementations, the operator may authenticate with system 300 (e.g., using a username and password), while in other implementations, the user device 330 may automatically and/or semiautomatically authenticate with system 300 (e.g., using stored credentials, a stored identifier from the user device 330, a key file, biometrics, and/or any other authentication method). Once authenticated, user device 330 may typically display to the operator one or more locations to which system 300 has one or more location emergency data profiles associated therewith.

In some implementations, system 300 may return location results for location emergency data based on a multitude of input factors. For example, user device 330 may display geographic locations having available location emergency data based on the closed locations using the user device 330's GPS, radio triangulation, and/or other telemetry mechanism. In other implementations, an operator may input a geographic location using an input device (e.g., keyboard, touchscreen, microphone, and/or the like), and system 300 may perform a real-time and/or on-command relevance search for similar geographic locations saved with system 300.

In still further implementations, user device 330 may also receive a push/pull notifications from system 300 and/or other controller devices (e.g., other user devices 330 associated with system 300) such that user device 330 being used by a responding operator may automatically, semiautomatically, and/or manually be populated with the requesting geographic location and associated location emergency data.

In yet another implementation, system 300 and/or user devices 330 may automatically query a geographic location based on geofencing. For example, once user device 330 comes within one mile (e.g., based on GPS, triangulation, and/or other telemetry mechanisms) of a geographic location, user device 330 may query system 300 for the location emergency data associated with the nearby geographic location.

In further implementations, automatic and/or semiautomatic query of location emergency data may be triggered after a system 300 operator sets a condition (e.g., flag, bit, and/or other indicator mechanism) on system 300, thus user device 330 may not query and/or retrieve location emergency data of each irrelevant geographic location while traveling to the requesting emergency location.

Additionally, during the “receive location emergency data matching geographic location” 490 step, system 300 may typically disseminate matching and/or relevant location emergency data associated with the queried geographic location to one or more user devices 330. For example, system 300 may send a data package including location emergency data (e.g., aerial representation, icon overlay, icon notations, etc.), a single file (e.g., a static aerial representation with icon overlay and legend), and/or any other data to user device 330 of the emergency services operators responding to the request.

Furthermore, during the “consult location emergency data for location layout, hazardous conditions, and safety protocols” 500 step, an emergency services operator may typically review retrieved and displayed location emergency data on user device 330. For example, retrieved location emergency data may depict the entrance to the geographic location (e.g., driveway, access road, and/or the like); most direct path to shutoff valves; location of water sources; location of hazardous materials; inhabited structures; and/or any other number of informative aspects of the geographic location awaiting the emergency services operators. Ideally, such information may be consulted before and/or en route to the geographic location, but such data may obviously be consulted while at the geographic location as well.

During the “resolve emergency response request” 510 step, typically operator indicates to system 300 that location emergency data is no longer needed (i.e., because the emergency response is resolved). Typically, this step may, where necessary, have the operator clear any emergency flag, bit, and/or other indicator associated with the geographic location. Thus, for example, geofencing may no longer activate user device 330 to query and/or receive location emergency data when in the vicinity of the geolocation. In some implementations, statistical data (e.g., total time request was active, time to travel to geolocation, total time at geolocation, total time on certain roadways, total time reviewing location emergency data, average time reviewing location emergency data, the number of times emergency services have responded to a specific geolocation, and/or the like. In some further implementations, this data may be analyzed, compared, extrapolated, exported, manipulated, and/or otherwise used by system 300 and/or other parties to determine trends, optimize parameters (e.g., response times, difficulties in navigating system 300's user interface, and/or the like).

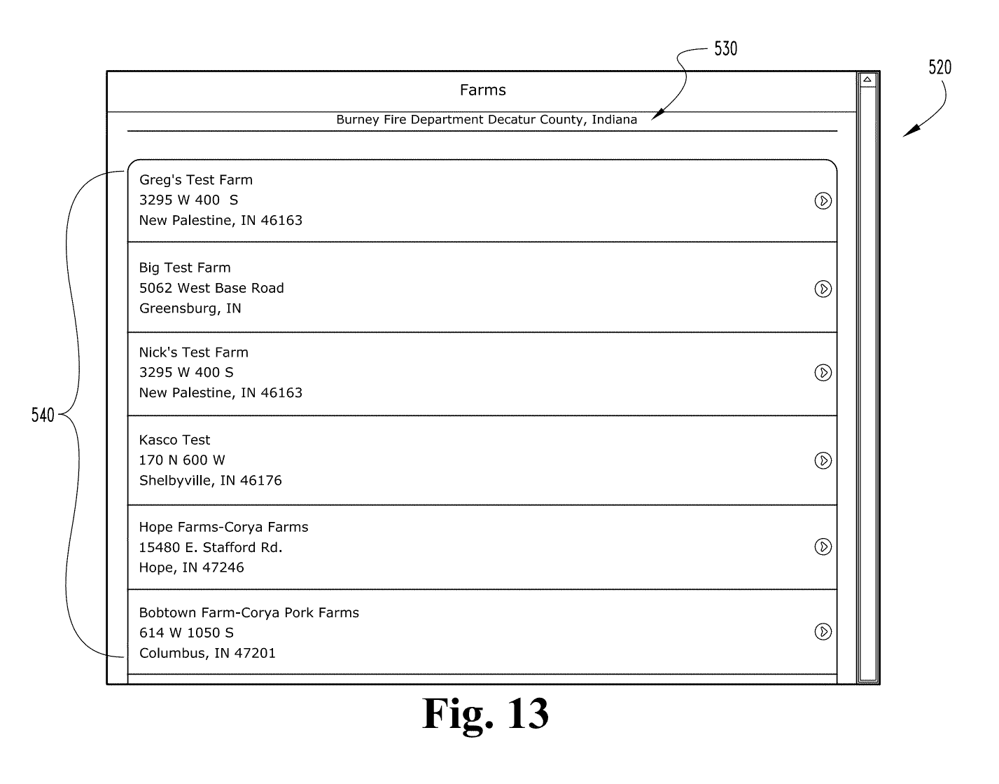

FIG. 13 depicts a screenshot of an example locations view 520 of the emergency planning system. Locations view 520 typically may include emergency services identifier 530 and/or geolocations 540 (also “geolocation field” but referred to as “geolocations” for ease of reference). Locations view 520 typically may query system 300 for stored geolocations with associated location emergency data and then display results returned from the query on locations view 520 as geolocations 540.

Emergency services identifier 530 typically may be a field and/or other fillable area in which the name, location, and/or other information associated with an emergency services organization may be displayed. For example, as depicted in FIG. 13, emergency services identifier 530 may be the name of the emergency services organization (e.g., Burney Fire Department, Police Department, Emergency Medical Services, etc.), the local geolocation (e.g., Decatur County, Jones Township, etc.), a broader geolocation (e.g., Indiana, Midwest, United States, etc.), and/or the like. Emergency services identifier 530 may be automatically and/or semiautomatically populated based on the user credentials used to access system 300 from user device 330. For example, a user “BurneyFD” may correspond to the Burney Fire Department of Decatur County in Indiana, and this information may be automatically displayed as emergency services identifier 530.

Geolocations 540 typically may be presented as a selectable listing of returned geographic location results. This list may be typically sorted and/or otherwise organized (e.g., alphabetically, geographically, categorically (e.g., agricultural facility, industrial complex, commercial building, etc.) such that a user of device 330 may review and/or select a geolocation from the list. The user typically may indicate the desired geolocation to advance to selected location view 550 by tapping, clicking, and/or otherwise selecting the geolocation from the geolocations 540 list.

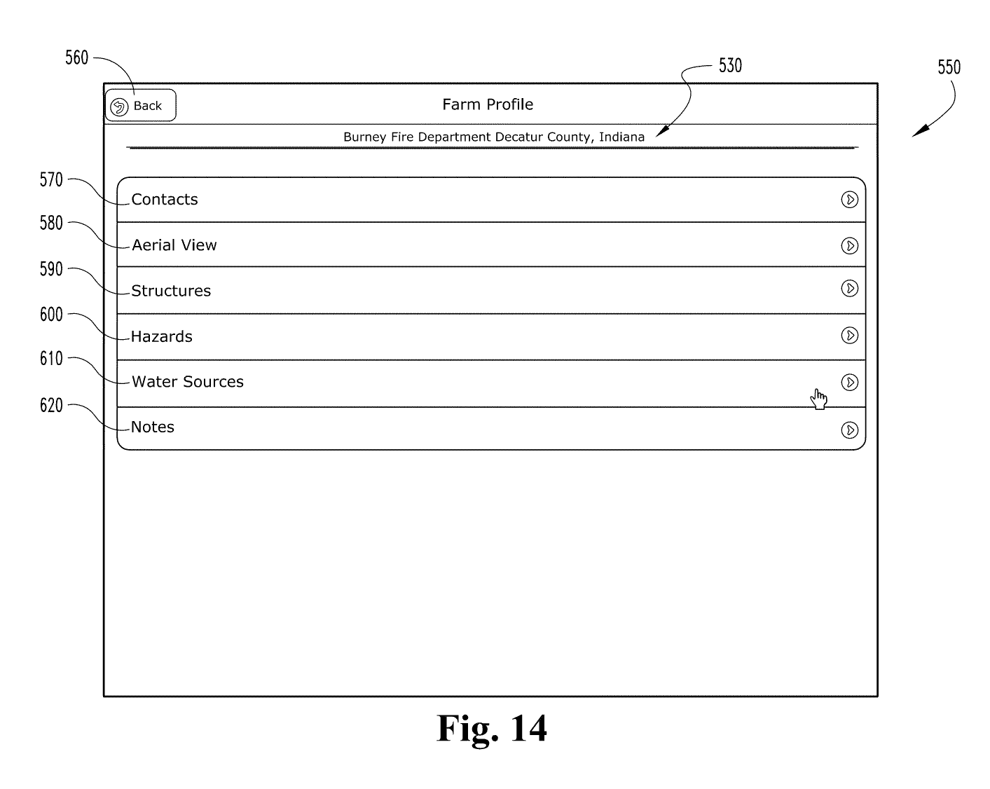

FIG. 14 depicts a screenshot of an example selected location view 550 of the emergency planning system. Selected location view 550 typically may include back selector 560, contacts data selector 570, aerial view data selector 580, structures data selector 590, hazards data selector 600, water sources data selector 610, and/or notes data selector 620.

Selecting (e.g., tapping, clicking, and/or otherwise indicating) back selector 560 typically may navigate user device 330 to an interface screen immediately prior/above selected location view 550 (e.g., locations view 520) in interface hierarchy. In some other implementations, selecting back selector 560 may navigate interface to a home screen (e.g., the highest, or one of a subset of highest, hierarchy levels for the interface tree).

Selecting contacts data selector 570, aerial view data selector 580, structures data selector 590, hazards data selector 600, water sources data selector 610, or notes data selector 620 may typically navigate user interface to contacts view 630, aerial view 650, structures view 690, hazards view 710, water sources view 730, and notes view 750, respectively. Each of these views are described elsewhere in this application.

In some implementations, a geolocation owner, operator, and/or manager may access system 300 using user device 330 and be presented with selected location view 550 automatically (or have to select from locations view 520). The user may then navigate through system 300 interface, adding data and/or assigning indicators for the geolocation. For example, the user may browse to contacts view 630 and add his or her contacts data 640 information, then browse to aerial view 650 to review the geolocation and assign indicators (e.g., 660, 670, 680, described below), browse to the structures view 690 to add information associated with each structure indicator 670 as structure data 700, browse to hazards view 710 and add known hazards data 720 and/or hazard reports (e.g., from environmental, utility, and/or other organizations), browse to water sources view 730 and add potential water sources as water sources data 740, and browse to notes view 750 to add helpful and/or required information (e.g., gate codes, worker lodging locations, etc.) as notes data 760. This information may be saved by system 300, for example on system database(s) 390, and/or transmitted to emergency services automatically and/or upon request from system 300.

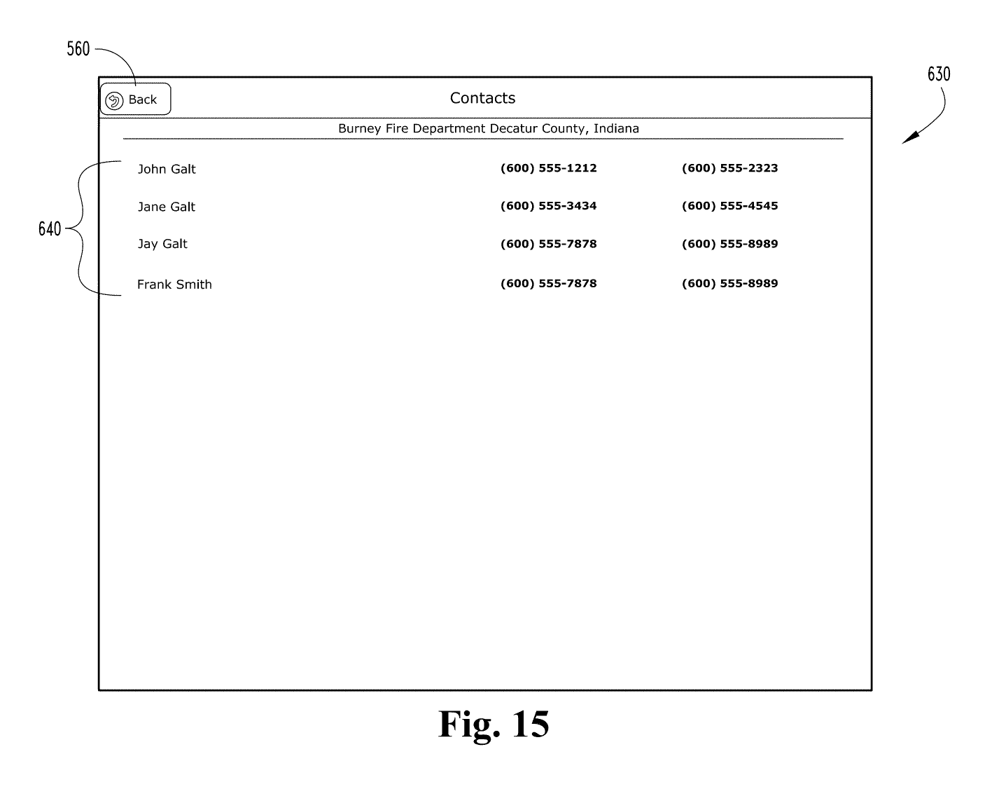

FIG. 15 depicts a screenshot of an example contacts view 630 of the emergency planning system. Contacts view 630 typically may include back selector 560 and/or contacts data 640.

As described above with reference to back selector 560 of selected location view 550, selecting back selector 560 typically may navigate user interface from contacts view 630 to a previous and/or higher level interface screen. In this case, for example, to selected location view 550 and/or any other previously browsed interface screen.

Contacts data 640 typically may depict one or more individuals and/or organizations associated with the selected geolocation. For example, as depicted in FIG. 15, individuals may be listed in a first column, phone numbers may be listed in a second column, and phone numbers may be listed in a third column. In some implementations, contacts data 640 may also list how the individuals/organizations are associated with the selected geolocation, the contact's email addresses, home/work addresses, associated security and/or executive personnel, and/or the like. In some further implementations, selecting a specific contact from the contacts data 640 list may expand and/or navigate interface to another screen listing further information and/or allowing quick connection with that contact.

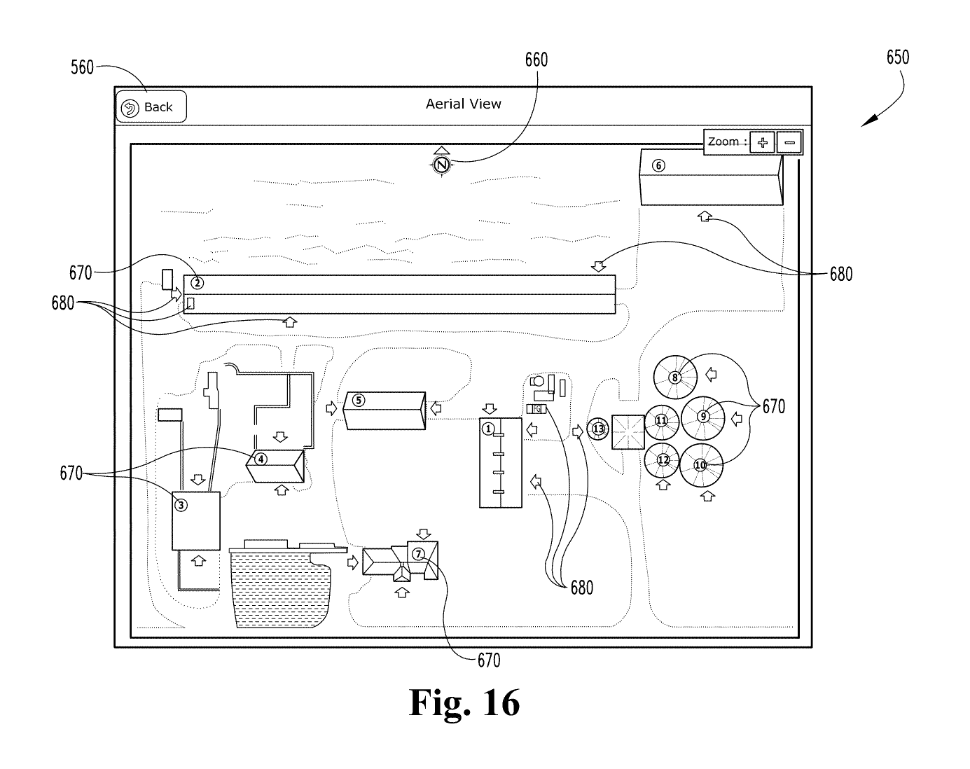

FIG. 16 depicts a screenshot of an example aerial view 650 of the emergency planning system. Aerial view 650 typically may include back selector 560 and/or directional indicator 660, structure indicators 670, and/or secondary indicators 680.

As described above with reference to back selector 560 of selected location view 550, selecting back selector 560 typically may navigate user interface from aerial view 650 to a previous and/or higher level interface screen. In this case, for example, to selected location view 550 and/or any other previously browsed interface screen.

Directional indicator 660 typically may be a compass rose, a direction text (e.g., “North,” “South,” etc.), and/or any other direction indication mechanism. Directional indicator 660 may act as a reference point for viewing and/or orienting a viewer's understanding of aerial view 650. For example, when adding structure indicators 670 and/or secondary indicators 680, it may be beneficial for a user to work from one direction (e.g., North) to another (e.g., South) to logically assign indicators (e.g., 670 and/or 680). Directional indicator 660 may also allow emergency responders to more effectively orient themselves when approaching and/or resolving an emergency request at a geolocation.

Structure indicators 670 typically may depict physical buildings and/or the like at the geolocation. For example, these structures may be, but are not limited to, barns, houses, sheds, processing facilities, bathrooms, silos, and/or the like. Structure indicators 670 may typically be numbers, letters, symbols, and/or any other differentiation and/or labeling mechanism to uniquely assign structures and/or subsets of structures.

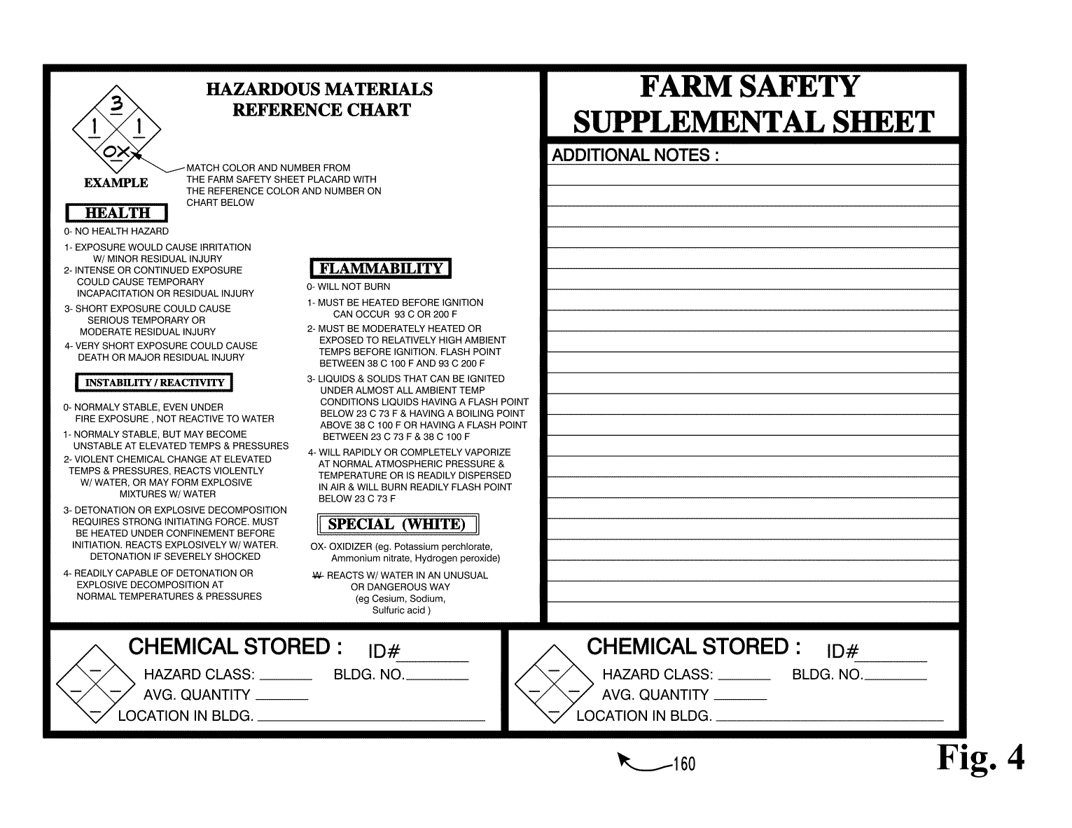

Secondary indicators 680, like structure indicators 670, typically may depict points of interest and/or utilities. For example, such secondary features may include, but are not limited to, electrical boxes, telecommunication pedestals, electrical service feeds, roads, fire suppression systems, entryways, exits, water sources, sewage lines/tanks, and/or the like. Secondary indicators 680 may typically be numbers, letters, symbols, and/or any other differentiation and/or labeling mechanism to uniquely assign structures and/or subsets of structures. In some implementations, secondary indicators 680 may be iconic and/or descriptive in appearance (e.g., such as those on FIGS. 4-6 and the like).

Typically, directional indicator 660, structure indicators 670, and/or secondary indicators 680 may be assigned automatically, semiautomatically, and/or manually as an overlay to the aerial representation of the geolocation. For example, as described elsewhere in this application, the structures and/or geolocation features may be indexed as GPS coordinate having associated descriptions (e.g., size, material, use, etc.), which may then be automatically mapped onto the aerial view as an overlay at those coordinates (either as absolute coordinates and/or relative coordinates). Similarly, a user may select indicators (660, 670, and/or 680) from a popup, menu, and/or other presentation mechanism to select, drag-and-drop, and/or otherwise associate one or more indicators with one or more locations on the aerial representation of the geolocation.

In some implementations, for example as shown in FIG. 3, a legend may be generated and/or displayed based on the indicators (660, 670, and/or 680) overlaid on the geolocation aerial representation on aerial view 650.

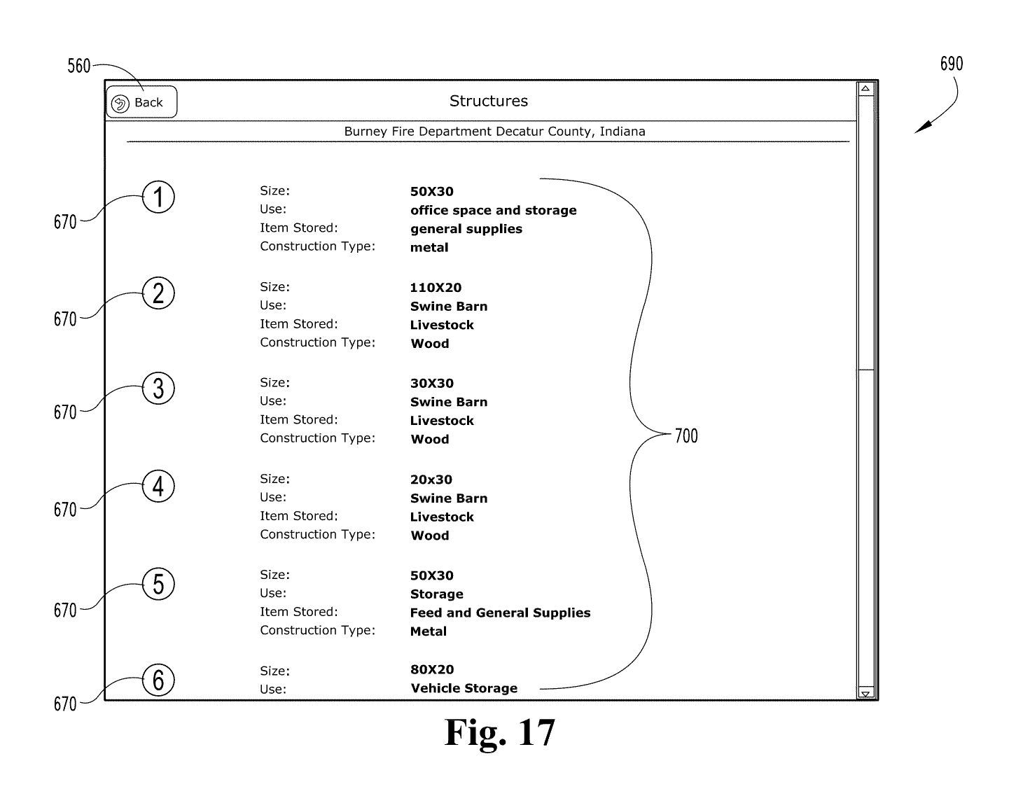

FIG. 17 depicts a screenshot of an example structures view 690 of the emergency planning system. Structures view 690 typically may include back selector 560, structures indicators 670, and/or structure data 700.

As described above with reference to back selector 560 of selected location view 550, selecting back selector 560 typically may navigate user interface from structures view 690 to a previous and/or higher level interface screen. In this case, for example, to selected location view 550 and/or any other previously browsed interface screen.

Structure indicators 670 typically may correspond with the overlaid structure indicators 670 on as described and depicted in FIG. 16. For example, as depicted on FIG. 16, “1” may correspond to the central, rectangular structure, “2” may correspond to the long, thin rectangular structure running from left to right, and so on. FIG. 17 then describes the attributes of these associated structures. Thus, “1” is used for office space and storage of general supplies, is made of metal, and is approximately fifty by thirty (feet, although any unit may be used). Similarly, “2” is used for swine livestock, is constructed of wood, and is approximately one hundred and ten by twenty units.

In some implementations, as described above, system 300 may automatically and/or semiautomatically populate structure indicators 670 and/or structure data 700 based on saved information (e.g., from system databases 390). For example, system database 390 may have one or more discrete and/or interrelated tables containing geolocations, structures, contacts, and/or other information associated with system 300 geolocations. System 300 interface may then query database 390, retrieve this data (e.g., structures indicators 670 associated with the FIG. 16 geolocation and the structure data 700), and then populate structures view 690.

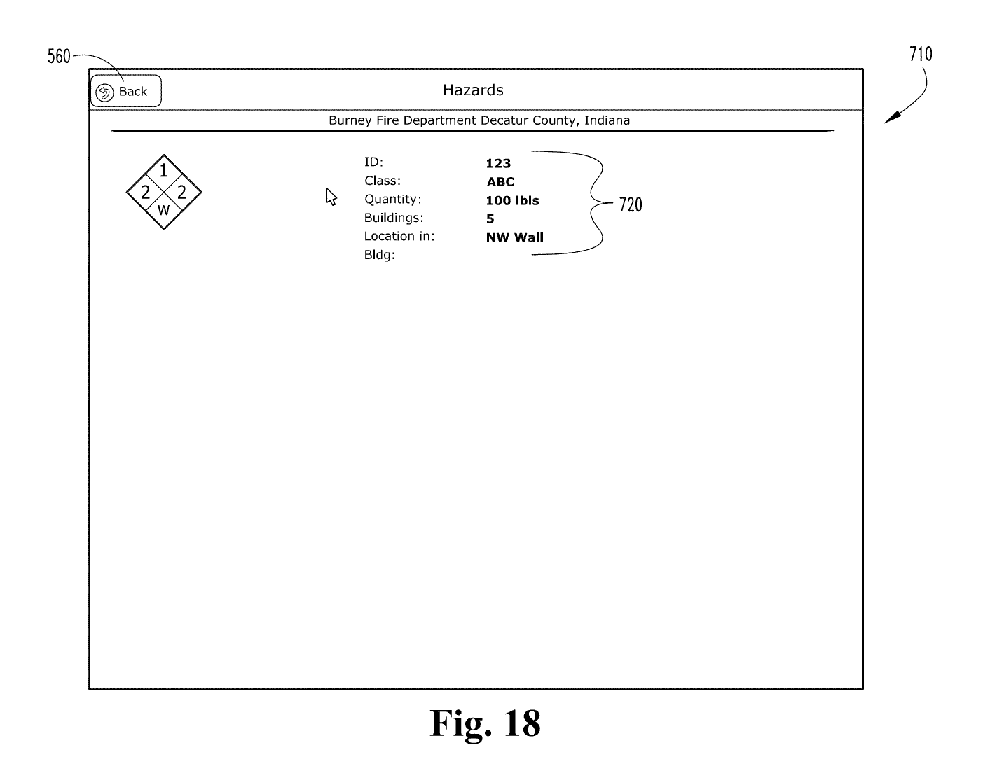

FIG. 18 depicts a screenshot of an example hazards view 710 of the emergency planning system. Hazards view 710 typically may include back selector 560 and/or hazards data 720.

As described above with reference to back selector 560 of selected location view 550, selecting back selector 560 typically may navigate user interface from hazards view 710 to a previous and/or higher level interface screen. In this case, for example, to selected location view 550 and/or any other previously browsed interface screen.

Similar to structures view 690, hazards view 710 and hazards data 720 typically may be automatically and/or semiautomatically populated based on saved information (e.g., from system databases 390). System 300 may then query database 390, retrieve this data (e.g., hazard data 720 associated with the FIG. 16 geolocation), and then populate hazards view 720. Such information may, for example, be required and/or used for safety inspections, training, and/or at-a-glance triage of an emergency request at a geolocation.

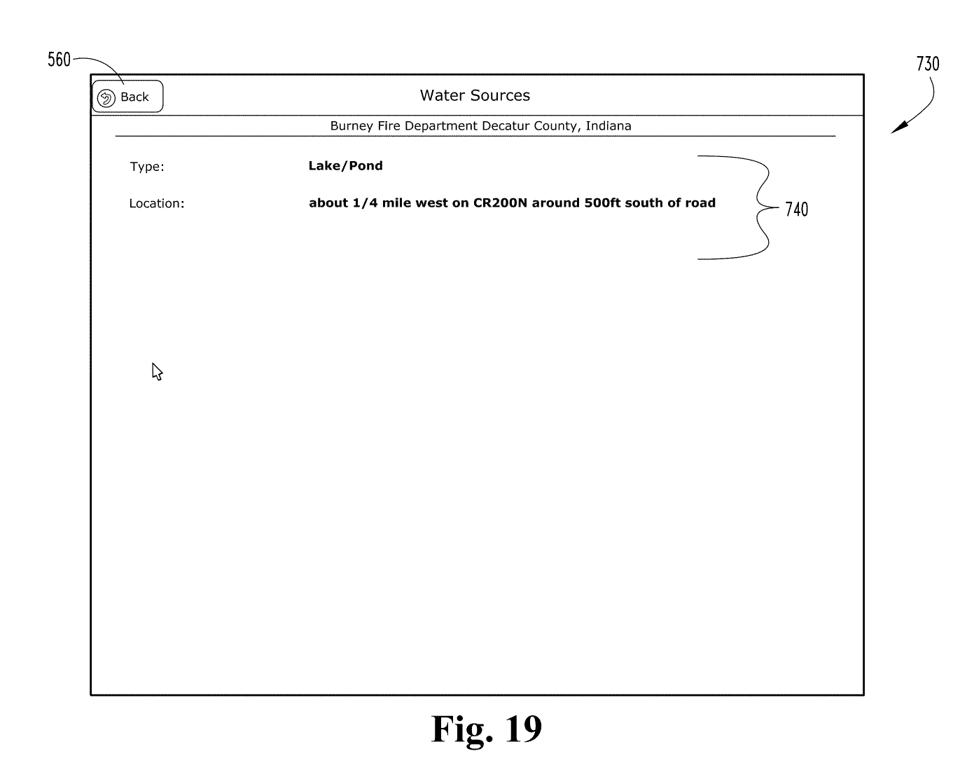

FIG. 19 depicts a screenshot of an example water sources view 730 of the emergency planning system. Water sources view 730 typically may include back selector 560 and/or water sources data 740.

As described above with reference to back selector 560 of selected location view 550, selecting back selector 560 typically may navigate user interface from water sources view 730 to a previous and/or higher level interface screen. In this case, for example, to selected location view 550 and/or any other previously browsed interface screen.

Again, similar to structures view 690 and hazards view 710, water source view 730 and/or water sources data 740 typically may be automatically and/or semiautomatically populated, queried, saved, and/or the like. Such information may, for example, allow emergency services to locate potential extinguishing sources in the event that emergency water sources (e.g., hydrants, fire suppression, etc.) are unavailable and/or ineffective.

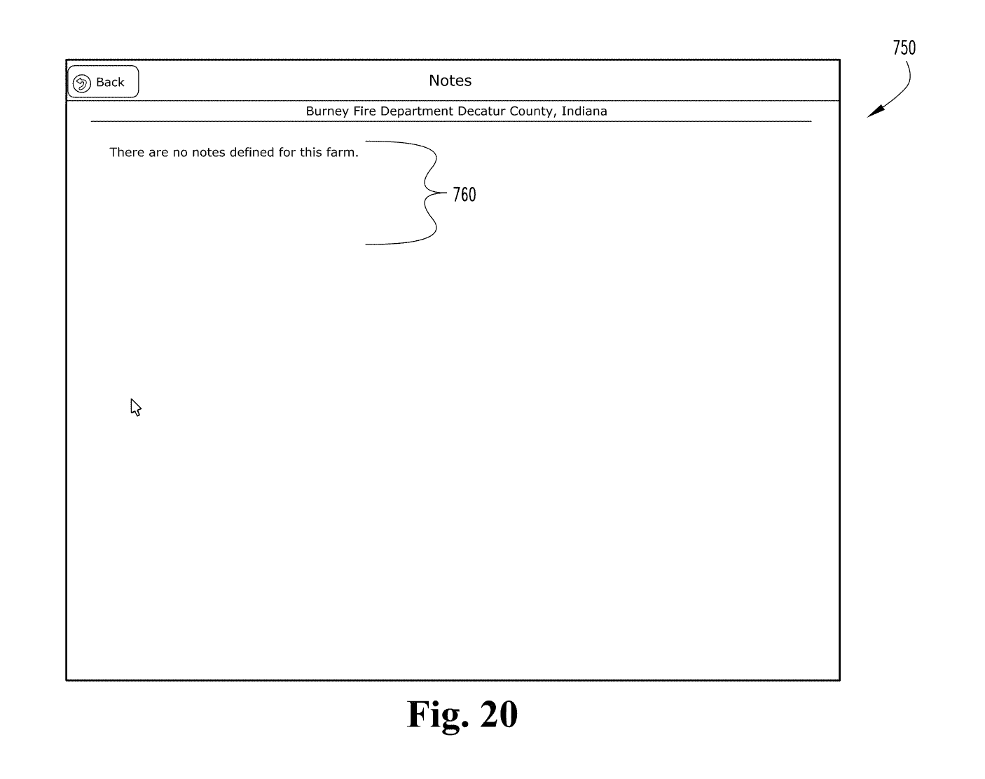

FIG. 20 depicts a screenshot of an example notes view 750 of the emergency planning system. Notes view 750 typically may include back selector 560 and/or notes data 760.

As described above with reference to back selector 560 of selected location view 550, selecting back selector 560 typically may navigate user interface from notes view 750 to a previous and/or higher level interface screen. In this case, for example, to selected location view 550 and/or any other previously browsed interface screen.

Notes view 750 and/or notes data 760 also typically may be automatically and/or semiautomatically populated, queried, saved, and/or the like. Such information may, for example, allow geolocation owners, inspectors, responders, and/or managers to denote important information to reference. For example, notes data 760 may include, but is not limited to, lock combinations, key locations, previous issues, maintenance reports, inspection reports, utility work, extremely urgent areas (e.g., housing with children), and/or the like.

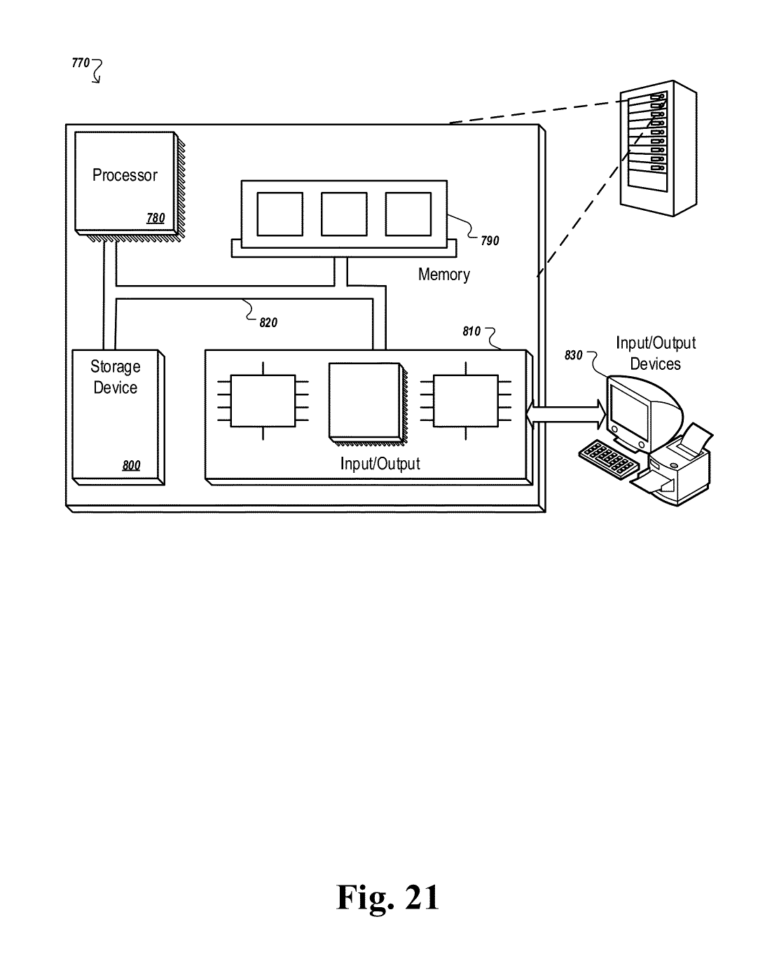

FIG. 21 is a block diagram of an example computer system 770 that may be used to provide emergency planning system 300, as described above. The system 770 may typically include processor(s) 780; memory 790; storage device(s) 800; system input(s)/output(s) 810; system bus(es) 820; and input/output device(s) 830. Each of the components 780, 790, 800, and 810 typically may be interconnected, for example, using system bus(es) 820. Processor(s) 780 may be capable of processing instructions for execution within the system 770. In one implementation, processor(s) 780 may be a single-threaded processor. In another implementation, processor(s) 780 may be a multi-threaded processor. In yet another implementation, processor(s) 780 may be a single-core processor, a multiple-core processor, and/or multiple processors (i.e., more than one socketed processor). Processor(s) 780 typically may be capable of processing instructions stored in the memory 790 and/or on the storage device(s) 800.

Memory 790 stores information within system 770. In one implementation, memory 790 may be a computer-readable medium. In one other implementation, memory 790 may be a volatile memory unit. In another implementation, memory 790 may be a nonvolatile memory unit.

Storage device(s) 800 may be capable of providing mass storage for the system 770. In one implementation, storage device(s) 800 may be a computer-readable medium. In various different implementations, storage device(s) 800 may include, for example, a hard disk device, a solid-state disk device, an optical disk device, and/or some other large capacity storage device.

System input(s)/output(s) 810 provide input/output operations for the system 770. In one implementation, system input(s)/output(s) 810 may include one or more of a network interface devices, for example an Ethernet card; a serial communication device, for example an RS-232 port; and/or a wireless interface device, for example an IEEE 802.11 card. In another implementation, system input(s)/output(s) 810 may include driver devices configured to receive input data and send output data to other input/output device(s) 830, for example keyboards, printers, display devices, and/or any other input/output device(s) 830. Other implementations, however, may also be used, such as mobile computing devices, mobile communication devices, set-top box television client devices, etc.

Although an example processing system has been described in FIG. 21, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented as a method, in digital electronic circuitry, or in computer software, firmware, or hardware, including the structures disclosed in this specification and their structural equivalents, or in combinations of one or more of them. Embodiments of the subject matter described in this specification may be implemented as one or more computer programs—that is, one or more modules of computer program instructions encoded on computer storage medium for execution by, or to control the operation of, data processing apparatus. Alternatively or in addition, the program instructions may be encoded on an artificially-generated propagated signal, for example a machine-generated electrical, optical, or electromagnetic signal, which may be generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium may not be a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus may include special purpose logic circuitry, for example an field programmable gate array (FPGA) or an application-specific integrated circuit (ASIC). The apparatus may also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing, and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program can, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, for example an FPGA or an ASIC.

Processors suitable for the execution of a computer program include, by way of example, both general and special purpose microprocessors, and any one or more processors of any kind of digital computer. Typically, a processor may receive instructions and data from a read-only memory or a random access memory or both. The essential elements of a computer are a processor for performing actions in accordance with instructions and one or more memory devices for storing instructions and data. Typically, a computer may also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, for example a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, for example erasable programmable read-only memory (EPROM), electrically erasable programmable read-only memory (EEPROM), and/or flash memory devices; magnetic disks, for example internal hard disks or removable disks; magneto-optical disks; and/or compact disk read-only memory (CD-ROM) and digital video disk real-only memory (DVD-ROM) disks. The processor and the memory may be supplemented by, or incorporated in, special purpose logic circuitry.

To provide for interaction with a user, embodiments of the subject matter described in this specification may be implemented on a computer having a display device (e.g., a cathode ray tube (CRT), liquid crystal display (LCD), or organic light-emitting diode (OLED) monitor), for displaying information to the user and a keyboard and a pointing device, e.g., a mouse or a trackball, by which the user may provide input to the computer. These may, for example, be desktop computers, laptop computers, smart TVs, etc. Other mechanisms of input may include portable and or console entertainment systems such as GAME BOY and/or NINTENDO DS ((GAME BOY, GAME BOY COLOR, GAME BOY ADVANCE, NINTENDO DS, NINTENDO 2DS, and NINTENDO 3DS are registered trademarks of Nintendo of America Inc., a Washington corporation, located at 4600 150th Avenue NE, Redmond, Wash. 98052), IPOD (IPOD is a registered trademark of Apple Inc., a California corporation, located at 1 Infinite Loop, Cupertino, Calif. 95014), XBOX (e.g., XBOX, XBOX ONE) (XBOX and XBOX ONE are a registered trademarks of Microsoft, a Washington corporation, located at One Microsoft Way, Redmond, Wash. 98052), PLAYSTATION (e.g., PLAYSTATION, PLAYSTATION 2, PS3, PS4, PLAYSTATION VITA) (PLAYSTATION, PLAYSTATION 2, PS3, PS4, and PLAYSTATION VITA are registered trademarks of Kabushiki Kaisha Sony Computer Entertainment TA, Sony Computer Entertainment Inc., a Japanese corporation, located at 1-7-1 Konan Minato-ku, Tokyo, 108-0075, Japan), OUYA (OUYA is a registered trademark of Ouya Inc., a Delaware corporation, located at 12243 Shetland Lane, Los Angeles, Calif. 90949), WII (e.g., WII, WII U) (WII and WII U are registered trademarks of Nintendo of America Inc., a Washington corporation, located at 4600 150th Avenue NE, Redmond, Wash. 98052), etc.

Other kinds of devices may be used to provide for interaction with a user as well; for example, feedback provided to the user may be any form of sensory feedback, for example visual feedback, auditory feedback, or tactile feedback; and input from the user may be received in any form, including acoustic, speech, or tactile input. In addition, a computer may interact with a user by sending documents to and receiving documents from a device that may be used by the user; for example, by sending webpages to a web browser on a user's client device in response to requests received from the web browser.

Some embodiments of the subject matter described in this specification may be implemented in a computing system 770 that includes a back-end component (e.g., a data server,) or that includes a middleware component (e.g., an application server,) or that includes a front-end component (e.g., a client computer having a graphical user interface or a Web browser through which a user may interact with an implementation of the subject matter described in this specification,) or any combination of one or more such back-end, middleware, or front-end components. The components of the computing system 770 may be interconnected by any form or medium of digital data communication, for example a communication network. Examples of communication networks include a local area network (LAN) and a wide area network (WAN), an inter-network (e.g., the Internet), and peer-to-peer networks (e.g., ad-hoc peer-to-peer, direct peer-to-peer, decentralized peer-to-peer, centralized peer-to-peer, etc.).

The computing system 770 may include clients and servers. A client and server are typically remote from each other and typically interact through a communication network. The relationship of client and server arises by virtue of computer programs running on the respective computers and having a client-server relationship to each other. In some embodiments, a server transmits data (e.g., an HTML webpage) to a client device (e.g., for purposes of displaying data to and receiving user input from a user interacting with the client device). Data generated at the client device (e.g., a result of the user interaction) may be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system 300 components in the embodiments described above should not be understood as requiring such separation in all embodiments, and it should be understood that the described program components and systems may typically be integrated together in a single hardware and/or software product or packaged into multiple hardware and/or software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for establishing an emergency planning system over a computer network, comprising the steps of:
selecting a geographic location;
receiving an aerial representation of the geographic location;
overlaying the aerial representation with at least one icon;
generating location emergency data for the geographic location based on the aerial representation and the at least one icon overlay; and
publishing the location emergency data.

2. The method of claim 1, further comprising the steps of:
receiving an emergency request associated with the geographic location;
querying at least one database for the location emergency data associated with the geographic location; and
receiving the location emergency data for the geographic location on at least one user device.

3. The method of claim 1, further comprising the steps of:
consulting the location emergency data; and
resolving the emergency request.

4. The method of claim 1, wherein the geographic location comprises a plurality of geographic locations.

5. The method of claim 1, wherein the geographic location is received from a GPS sensor.

6. The method of claim 1 wherein the at least one icon further comprises:
at least one structure indicator; and
at least one secondary indicator.

7. The method of claim 1, wherein the location emergency data is generated and displayed as an aerial view.

8. A system for providing an emergency planning system over a computer network configured to overate over a network using a server and at least one end user device, comprising:
a server operating the emergency planning system, the server adapted to communicate with the network;
wherein the server is configured to:
select a geographic location;
receive an aerial representation of the geographic location;
overlay the aerial representation with at least one icon;
generate location emergency data for the geographic location based on the aerial representation and the at least one icon overlay; and
publish the location emergency data.

9. The system of claim 8, where the server is further configured to:
receive an emergency request associated with the geographic location;
query at least one database for the location emergency data associated with the geographic location; and
receive the location emergency data for the geographic location on at least one user device.

10. The system of claim 8, where the server is further configured to:
consult the location emergency data; and
resolve the emergency request.

11. The system of claim 8, wherein the geographic location comprises a plurality of geographic locations.

12. The system of claim 8, wherein the at least one icon further comprises:
at least one structure indicator; and
at least one secondary indicator.

13. The system of claim 8, wherein the location emergency data is generated and displayed as an aerial view.

14. The system of claim 8, wherein the geographic location is received from a GPS sensor.

15. An emergency planning kit, comprising:
an information sheet;
at least one sheet of preprinted icons; and
a weather-resistant box.

16. The emergency planning kit of claim 15, wherein the information sheet further comprises a condensed sheet.

17. The emergency planning kit of claim 15, wherein the at least one sheet of preprinted icons further comprises:
a first sheet of preprinted icons; and
a second sheet of preprinted icons;
wherein the first sheet of preprinted icons further comprises at least one structural indicator; and
wherein the second sheet of preprinted icons further comprises at least one secondary indicator.

18. The emergency planning kit of claim 15, further comprising a shelter.

19. The emergency planning kit of claim 16, wherein the information sheet is the condensed sheet.

20. The emergency planning kit of claim 15, further comprising a software subscription to an emergency planning system.
